(19) United States
(12) Patent Application Publication
(10) Pub. No.: US 2007/0066403 A1
(43) Pub. Date: Mar. 22, 2007

(54) Method for dynamically adjusting an interactive application such as a videogame based on continuing assessments of user capability

(76) Inventor: George Colby Conkwright, Honolulu, HI (US)

Correspondence Address: LEIGHTON K. CHONG;GODBEY GRIFFITHS REISS & CHONG, 1001 BISHOP STREET, PAUAHI TOWER SUITE 2300, HONOLULU, HI, 96813, US

(21) Appl. No.: 11/232,189

(22) Filed: Sep. 20, 2005

(51) Int. Cl. A63F 13/00

(52) U.S. Cl. 463/43

(57) ABSTRACT

A method of balancing a user's input to an interactive computer program with the program's output is obtained by continually measuring the difference between the user's input and the program's output and adjusting one or more parameters of the program's output so that the difference from the user's performance is progressively reduced. The adjustment may be obtained dynamically through negative feedback dampening of the measured difference (delta) between user input and program output, and/or by selection of predetermined apposite values for program output corresponding to the measurement of user input. The adjustment results in dynamic generation and/or selection of premodeled segments of interactive output in closer balance with user input. The adjustment method can be applied to video games, educational games, productivity programs, training programs, biofeedback programs, entertainment programs, and other interactive programs. In video games, the adjustment method results in balancing user performance with game difficulty for a more engaging game experience. It can also enable embedded advertising to be triggered when the user is in an optimum state of engagement. The adjustment method may be performed by projecting future trends of user performance, selecting predetermined or dynamically determined levels of value, modifying user control of input devices, or even modifying the program's challenges to user capability over time.

### FIELD OF INVENTION

This invention relates to a system and method for dynamically adjusting an interactive application such as a videogame program by progressively balancing interaction difficulty with user/player capability over time.

### BACKGROUND OF INVENTION

In the prior art there have been many systems that employ functions to adapt responses to or to “learn” from user responses over time. Typically, such systems measure a user's inputs and make negative-feedback adjustments to correct for undesired variations between the user's input and the intended result or performance. For example, in certain types of videogames, an attempt may be made to balance videogame difficulty with player capability. In the simplest example, a videogame may have different “levels” of game play which increase in difficulty, and a player must complete a level or perform certain tasks to reach the next level. However, this type of level-setting is made in gross steps that require the player to complete one narrative level before moving on to the next level. A skilled player may have to go thorugh several levels before reaching one that is more matched to his/her capability.

A more sophisticated type of interactive game may employ a learning algorithm that alters the game response to a successful player pattern. For example, in the ‘Virtua Fighter’ (Sega), ‘Tekken’ (Namco), and ‘Mortal Kombat’ (Midway) fighting games, the game control can select a different response to a player's move or combination of moves that is used repetitiously with success. The advantage of this approach is that it prevents the player from using repetitious patterns which can defeat the game and/or keep the player from developing other skills necessary at higher levels. However, it is limited in that it does not analyze the relationship of game settings on player performance in order to make the change to the game response, and therefore does not progressively balance the game parameters to the player's capability.

Other types of interactive game programs may employ intelligent systems or neural networks in strategy games such as chess or battle simulations in order to improve the game's response against particular human opponents through repeated play. The advantage is that the program can simulate human-type interaction and improve both general performance and performance versus particular opponents over time. Some complex interactive applications may use predictive modeling to predict player behavior in strategy-based games, such as the ‘Deep Blue’ chess-playing program created by IBM Corp. However, these types of learning or predictive systems do not dynamically balance program response to measured assessments of player capability in current play.

Some types of videogames, such as ‘Wipeout’, ‘Super Monkey Ball’, and other racing games, alter the usefulness of race pickups depending on the player's position in race. This provides a stabilizing and balancing influence on the race, rewarding those behind and punishing those ahead. However, the magnitude of the balancing effects is not directly related to the requirements for balance. For example, a player may be farther behind than can be balanced by even the most useful pickup. Such racing games can alter the parameters for the leading and trailing CPU opponents to keep the player from being separated from all CPU opponents by too great a distance. This prevents the player from getting too far away (in either direction) from some element of game play. However, it only deals with the extremes, which is inherently non-progressive, and has little to do with the majority of the game play for all but the worst and best players.

Other types of videogames, such as ‘Extreme G’ and ‘Mario Kart’, provide a catch-up option a in two-player or multiplayer mode which bases the speed capability of the players' vehicles on some function of their separation. This helps balance game play between players of differing capabilities, but is not based on a progressive balancing of game response to a respective player's actual on-going capability over time. This method is not certain to improve game balance between two players, as the parameters being adjusted may not improve game balance (e.g., increasing vehicle capability for the more novice player may lead to more vehicle crashes, leading to further player separation).

Yet other types of videogames, such as the ‘Crash Bandicoot’, ‘Jak’ and ‘Daxter’, provide a catch-up option in a two-player or multiplayer mode. This allows a player to complete game stages with which he/she is having difficulty without a discouraging number of failed attempts, thus allowing more flow to the game. However, it allows a player to complete game stages without necessarily having mastered the appropriate skills. Also, since this adjustment does not affect future stages, an increase in these imbalances is likely to occur over time. This method also only puts a boundary on one side—that of being too difficult. Progressive balance is not possible in this case, since there is no determination of “why” the player did not have stage success.

In some PC strategy games, the game's difficulty setting is based on the ratio of a previous player's wins and losses. This automatically adjusts the overall difficulty of an entire game from a top-level goal, that of winning or losing. It does not adjust individual parameters up/down and does not progressively balance difficulty in response to assessments of the player's capability, as only the direction and not the magnitude of adjustments is related to player capability. Even if the magnitude were related, without a prediction system which learns over time, the adjustments may not be progressive (e.g. the player's improvement rate may be faster than the game's adjustment process).

Some types of multiplayer videogames, such as ‘Perfect Dark 360’ for XBOX 360, use dynamic stage generation in which the size of the arena is based on the number of players logged on to XBOX Live to participate in the game. In ‘Drome Racing Challenge’, a non-interactive narrative race presentation is constructed based on selection options of the players in order to provide a dramatic production of a balanced race. In Coded Arms, each new level/arena for a first person shooter game is randomly constructed before play starts. In the game ‘Rally Cross’ and some of the newer first person shooter games, the player is given the capability to customize racetracks and arenas to be played in the game. However, in all of these, the staging or narrative selection has no direct relationship to actual assessments of player capability, and therefore does not inherently balance game difficulty with player skill.

In some types of biofeedback games, such as Healing Rhythm's ‘Journey to the Wild Divine’ and Audiostrobe's ‘Mental Games’, performance is defined by the achievement of various physiological states of the player and reflected in the game visuals. However, the balancing of challenges is not player feedback-driven. The change in challenge difficulty through time is not directly related to the change in magnitude of player capability through time.

Adaptive predictive control systems have been previously known, for example as described in U.S. Pat. Nos. 4,358,822 and 4,197,576 to J. Martin-Sanchez, for controlling time-variant processes in real-time by determining what control vector should be applied to cause the process output to be at some desired value at a future time. However, these are used for mechanical processes but not the process of human interaction, and are simply methods by which a time-based directive is used to position an object in a desired relation to its intended target.

Some games such as ‘Prince of Persia’, ‘The Matrix’, ‘Burnout’, and ‘Max Payne’ use a feature commonly termed “bullet time”. Largely implemented for presentation purposes, this feature slows all aspects of the game down to a reduced rate so that the player has more psychological time in which to watch events transpire and/or to make better choices per unit of elapsed game time. Another feature, such as in the ‘Prince of Persia’ games, allow the player to rewind the game by some amount of time and essentially “undo” events which have led to poor performance results. However, these implementations are either based on presentation purposes or at the discretion of the player to use. They are not automatically based on or directed by player capability (other than extremes such as an undo option after a player's character dies) and are not correlated with player behavior through time, and therefore do not inherently provide any progressive balancing between player capability and game challenge and/or difficulty.

In contrast to the prior art, it is deemed desirable to increasingly balance game difficulty with player capability over time in order to provide a real-time response to a player's real-time play so that the gap between game difficulty and player capability becomes progressively smaller, thus decreasing the imbalance over time. It is believed that this kind of dynamic progressive adjustment to real-time play will give a skilled player the feeling of being “in the zone” with the game almost from inception to the end, and will alleviate the skilled game player's boredom, frustration, and premature quitting of game use.

### SUMMARY OF INVENTION

It is therefore a principal object of the present invention to provide a system and method for dynamically adjusting an interactive application, such as a videogame program, by increasingly balancing difficulty with user/player capability over time.

A more specific object of the invention is to balance game difficulty with player capability through selection of dynamic responses which have not been pre-programmed in gross “levels” or “sets” but rather are fine-tuned and responsive to actual conditions in real-time play.

In accordance with the present invention, a method for adjusting one or more parameters of interactivity between a user and an interactive application program programmed for operation on a computer, wherein the interactive application program is operable to measure a difference between one or more parameters of user performance input to the program and the program's interactive output to the user, and to adjust the corresponding parameters of successive interactive output by the program so that the difference between the user's performance and the program's interactive output is progressively reduced.

In one basic approach, the method of the present invention is implemented through negative feedback dampening. The dampening of the interactive output parameters is performed in a direction opposite to and by a fractional amount of the measured difference in parameters of user performance. In another basic approach, the adjusting of interactive output parameters is obtained through selection of apposite predetermined values for the parameters of the interactive output. The apposite predetermined values are derived by associating ranges of measured user performance with respective setting values for interactive output. The parameter adjustment may be implemented by dynamic generation of interactive output or by selecting premodeled segments of interactive output corresponding to the adjustment of parameters.

The invention method can be applied to many types of interactive programs, including video game programs, educational game programs, productivity programs, training programs, biofeedback programs, and entertainment programs. The interactive program can also include embedded advertising that is triggered when the user's measured performance input indicates an optimum state of receptivity. The adjustment of parameters may be performed by projecting future trends of user performance, by applying a fixed or dynamically determined adjustment value, by modifying control of input devices for user input, or even by modifying the interactive application's challenges to user capability over time.

In a preferred embodiment of the invention implemented for a videogame program, the adjustment is of a fractional amount and in an opposite direction from the calculated difference (delta) in player performance. If the player is succeeding at a performance goal for the game, the game difficulty is adjusted to be higher by a fractional amount of the delta. If the player is failing at a game goal, the difficulty is adjusted lower by a fractional amount. The adjustment of game parameters progressively reduces the difference between user performance of the game and the game goals. For racing simulation games, as a particular example, the user's racing performance can be balanced against a program-generated racing scene, a computer-controlled race car, and/or multiple computer-controlled race cars.

Other objects, features, and advantages of the present invention will be explained in the following detailed description of the invention having reference to the appended drawings.

### BRIEF DESCRIPTION OF DRAWINGS

FIG. 1 illustrates the core concept of the invention of progressively dampening the imbalance between an interactive application and a user or player's input over time.

FIG. 2 identifies the major processes involved in applying the invention to a videogame application.

FIG. 3 illustrates the location of the invention within the global architecture of videogame software.

FIG. 4 shows ‘game data’ and ‘logic engine’ modules in the videogame architecture for processing control through an event handler module.

FIG. 5 illustrates the parameter value setting and updating process controlled by the logic engine.

FIG. 6 is an example of an event handler's token interaction matrix for a simple racing simulation videogame.

FIG. 7 is an example of the invention applied to a racing simulation videogame, in which a flowchart illustrates adjustment of the difficulty settings of two variable game parameters (CPU CAR SPEED and AMOUNT OF TRAFFIC).

FIG. 8 is an example of the invention applied to a fighting-based videogame, in which a flowchart illustrates adjustment of the difficulty settings of four variable game parameters (REACTION SPEED, COMBO PROFICIENCY, OFFENSIVE AI, and DEFENSIVE AI).

FIG. 9 is an example of the invention applied to a racing simulation videogame showing adjustment of performance trends over time by calculation of numerical values for parameters as opposed to predefined settings.

FIG. 10 is an example of calculation of X and Y coordinate positions for a CPU-opponent in a racing simulation.

FIG. 11 illustrates meta-adjustments outside the core process including the rate of application of negative feedback based on effects on player performance as well as applying feedback at a higher level with respect to overall race results.

FIG. 12 shows an example of adjusting the options available to the player in the menuing system.

FIG. 13 shows an example of dynamically generating successive game content based on the difficulty parameter adjustment process, i.e., a dynamically-generated racetrack.

FIG. 14 is an example of dynamic generation of successive racetracks according to the instructions illustrated in FIG. 13.

FIG. 15 illustrates the use of optimization functions in order to simultaneously handle application of the invention to multiple player performance.

FIG. 16 is a detailed flowchart showing a general concept of interactivity parameters being adjusted from a high level control structure relative to a performance dimension.

FIG. 17 illustrates a detailed example of a table of hypothetical performance values relating to measurable performance boundaries.

FIG. 18 is a detailed flowchart showing interactivity parameters being adjusted from a high level control structure relative to selected performance dimensions.

FIG. 19 is a detailed example of a table of hypothetical performance values relating to measurable performance boundaries for an interactive program.

FIG. 20 is a detailed example of a more complex table of hypothetical performance values relating to measurable performance boundaries for an interactive program.

FIG. 21 is a detailed flowchart illustrating the adjustment steps for the conditions represented in FIG. 20.

FIG. 22 is a detailed flowchart showing dynamic iteration.

FIG. 23 shows detailed examples of actual parameter setting values for the example in FIG. 17.

FIG. 24 is a diagram showing a detailed example of adjustment steps applied to a videogame program.

FIG. 25 shows a detailed example of performance-setting relationships for a game situation.

FIG. 26 is a detailed flowchart showing a dynamic iteration process for an interactive program.

FIG. 27 shows sample data for negative feedback dampening method applied to a racing game simulation.

FIG. 28 is a chart showing the levels of possible implementation of the invention.

FIG. 29 is a schematic diagram illustrating an example of the dynamics of the player's input control with the described system.

FIG. 30 is a diagram illustrating the application of negative feedback dampening of a CPU-controlled opponent response in a videogame.

FIG. 31 is a diagram illustrating the application of the invention scheme with respect to multiple CPU opponents.

FIG. 32 shows a visual example of the application of the invention to a race sequence between a player and a CPU-controlled opponent in a videogame.

FIG. 33 shows a visual example of the application of the invention to a race sequence between a player and multiple CPU-controlled opponents in a videogame.

### DETAILED DESCRIPTION OF PREFERRED EMBODIMENTS

In the following detailed description, certain preferred embodiments are described as illustrations of the invention in a specific application, network, or computer environment in order to provide a thorough understanding of the present invention. However, it will be recognized by one skilled in the art that the present invention may be practiced in other analogous applications or environments and with other analogous or equivalent details. Those methods, procedures, components, or functions which are commonly known to persons in the field of the invention are not described in detail as not to unnecessarily obscure a concise description of the present invention.

Some portions of the detailed description that follows are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “translating” or “calculating” or “determining” or “displaying” or “recognizing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Aspects of the present invention, described below, are discussed in terms of steps executed on a computer system. In general, any type of general purpose, programmable computer system can be used by the present invention. A typical computer system has input and output data connection ports, an address/data bus for transferring data among components, a central processor coupled to the bus for processing program instructions and data, a random access memory for temporarily storing information and instructions for the central processor, a large-scale permanent data storage device such as a magnetic or optical disk drive, a display device for displaying information to the computer user, and one or more input devices such as a keyboard including alphanumeric and function keys for entering information and command selections to the central processor, and one or more peripheral devices such as a mouse. Such general purpose computer systems and their programming with software to perform desired computerized functions are well understood to those skilled in the art, and are not described in further detail herein.

Certain terminologies are used herein to have a specific meaning relevant to the subject matter described:

“Stage structure” refers to the staging parameters of a videogame, such as arena design, player avatar specifications, number, specifications, competitive level, settings of CPU opponents, associated graphics, significance of input controls, timing, and other parameter settings of a videogame stage or level.

“Entrainment” refers to the state of a player being carried along or falling into a rhythm with a game.

“Productive interaction” refers to an interaction that leads directly to interaction with less distortion.

“Negative feedback” refers to a feedback that negates an undesired condition to bring a system to a more stable state.

“Iteration” refers to a cyclic process where information derived from a one cycle is used in the next to achieve superior information.

“Narrative design” refers to a structuring of scenes or events constituting a narrative of a portion of a game or story.

“Play anxiety” refers to a state of play when there is more game challenge than player skill.

“Play boredom” refers to a state of play when there is more player skill than game challenge.

“Player skill” refers to a player's capability over time to achieve game goals.

“Emergent stages” refer to stage elements created on-the-fly as the player interacts with the game, arising from the operation of the game system.

“Inherently productive interaction” refers to an interaction that leads directly to further interaction with less distortion.

“Altering the direction of the user's performance trend” refers to adjustment of the difference between game difficulty and player performance by a selected amount of the difference magnitude and in the opposite direction so as to progressively move closer toward a balance between game difficulty and player performance.

“Command input” refers to any input by a user or player to an interactive application, such as by keystrokes on keyboard, command and/or navigation buttons on a controller, digital or analog joysticks, movement of a mouse touchpad or light pen, use of a digitizer, etc.

“Physiological input” refers to any input by a user or player to an interactive application by way of a biofeedback apparatus, such as EEG, pulse monitor, galvanic skin response, heart rate variability, pulse, brainwave frequencies, breathing patterns, eye movements, etc.

“Program post-sensory output” refers to any output from an interactive application which can be detected, sensed or felt by a human user or player, such as visual output to a display screen or light glasses, audio output to speakers or headphones, kinesthetic output to a tactile device, olfactory and gustatory output, etc.

“Program pre-sensory output” refers to any output from from an interactive application which cannot be detected by the human senses, and may or may not affect them, such as signal feedback that can alter neurological patterns, subliminal outputs, etc.

“Independent user performance trend” refers to the mathematical value direction of an individual user's performance since the last evaluation point toward goals measured by the interactive program.

“Productivity software” refers to a software application which helps a user to perform a task.

A general principle of the present invention is to achieve a balance between program interaction and user capability by continually reducing the difference between the user's measurable performance and the program target or goal. Essentially this is the combination of dynamic iteration and the continual altering of the direction of the perceived user performance trend with respect to mutual user-program goals. In a preferred implementation, a high level control structure adjusts selected parameter settings within an interactive program on a trend toward balance and consistency. User performance inputs relative to the interactive program can be taken in any desired way. The inputs can be a static or a dynamic condition, can be taken with the same or with increasing or decreasing frequency, can be made at fixed or variable time intervals and/or on the occurrence of predefined events. Any variable parameters in the game which can be correlated with player or user performance may be adjusted according to the Invention's principle of dynamic and progressive parameter balancing, including but not limited to, those parameters adjusted by the prior art. Examples of these include, AI level of CPU opponents, memory allocation to AI, speed of CPU opponents, visual frame rate of the game output (e.g. ‘bullet time’), complexity of background animations, win/loss ratios, number of opponents in the game scenario, aspects of game content, etc. Game challenge and/or difficulty can be expressed as CPU opponent play, speed of game, game complexity, capability of cooperative non player characters, ease of interface, or even unknown expressions representing some combination of parameter values, etc.

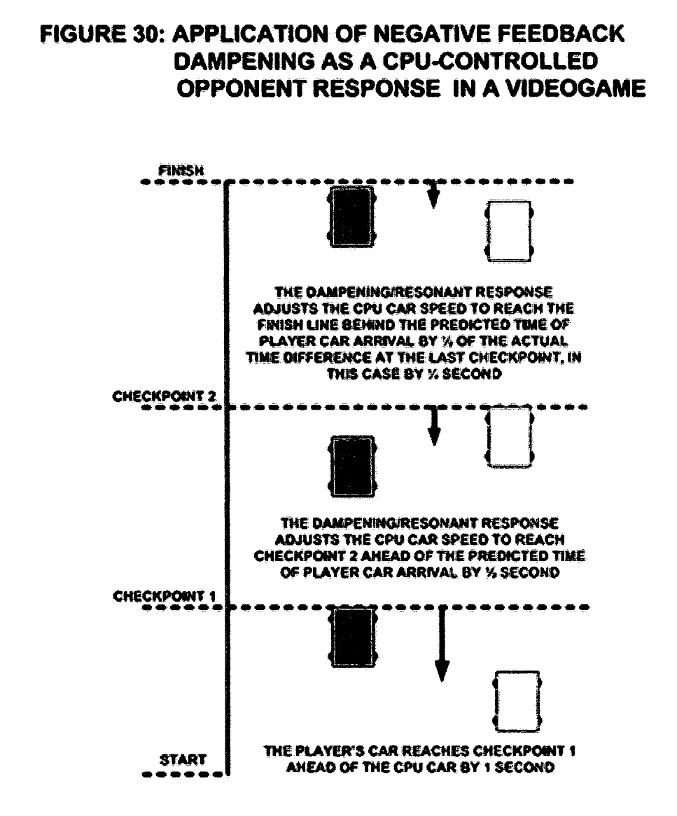

The invention can be implemented as an inherently progressive, negative feedback entrainment scheme (described in examples below and illustrated particularly in FIG. 30) or can be implemented as a non-directly progressive dynamic “apposite” parameter adjustment scheme which also inherently provides negative feedback. For example, the Invention can be implemented easily in rudimentary games like Atari's ‘Pong’ or Namco's ‘Pac Man’. As only one of many examples, the speed of the game (motion of tokenized characters and objects increased or decreased) can be made to be a function of player performance. One way to apply this linearly to all tokenized characters might be to simply alter the game output frame rate in the graphics engine as controlled by the logic engine. For example, in Pong, as the play ball or puck's ending position on the player side of the screen is known as soon as it leaves the CPU or opposing player stick, the speed of the game could be proportional to the inverse distance of the player's stick to that ending position location. With Pac-Man, the speed of the game could be a function of the inverse of the sum of the average distances of the monsters to the player's Pac-Man character. As these examples are not based on parameter correlations with through-time player performance trends and predictions, they are not directly progressive, although they are entirely dynamic and may be indirectly progressive in balancing player capability with game difficulty and/or challenge. These types of “apposite” implementations do not represent the optimal embodiment, but are more easily implemented into existing game architectures.

The fully progressive negative feedback dampening scheme will first be discussed in detail, after which examples of the “apposite” implementation will be described.

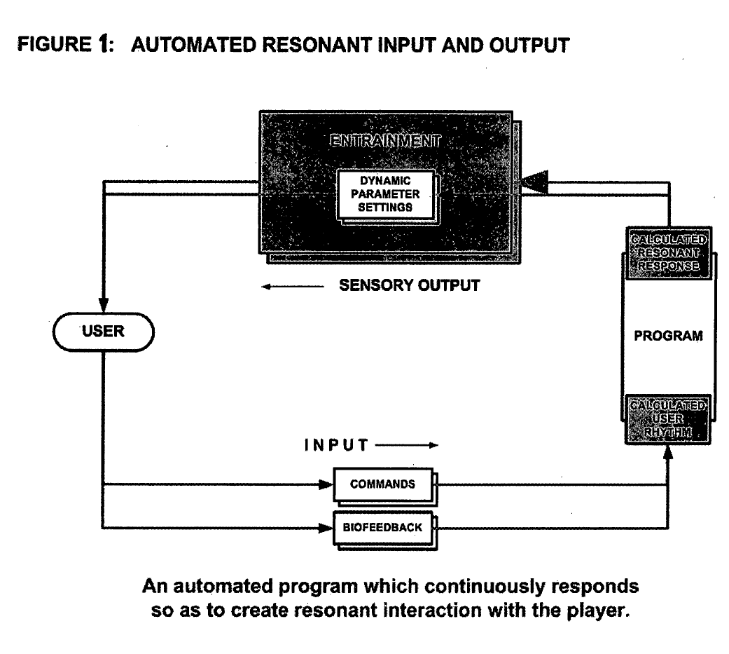

Referring to FIG. 1, this diagram represents a user or player interacting with an interactive application program such as a video game program in which the object is to achieve a resonant interaction between user and program. The user provides inputs to the program, in the form of input commands or biofeedback (physical) inputs. The program calculates the user's rhythm (degree of resonance) with the program and outputs a calculated response designed to bring the user into closer resonance with the program. The calculated response is used to change or modify the dynamic parameter settings for the program's display to or other interaction with the user in order to bring the user closer into resonance with the program, referred to herein as “entrainment”. The modified program provides a display or other sensory output to the user, on which the user further interacts with the program. In a preferred embodiment of the invention, this “entrainment” of the user/program interaction can be accomplished by progressively damping the application's interaction through negative feedback applied in an ongoing manner over time. The result is that the user feels “in sync” or “in the zone” with the interactive application, as the the entrainment becomes progressively closer to its optimum with respect to user/program interaction.

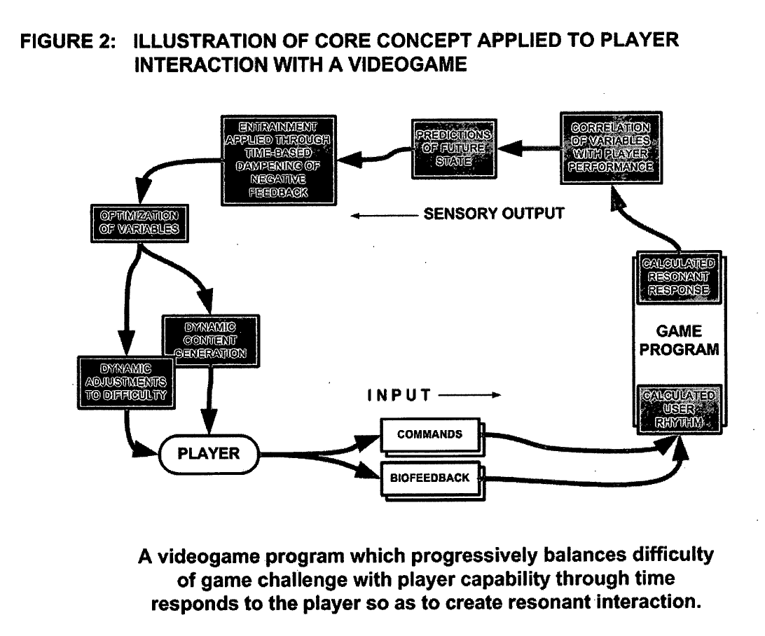

In FIG. 2, the entrainment process is illustrated for the example of a videogame as the interactive application. The object is to progressively balance the player's capability toward achieving game goals with the difficulty of the game as presented to the player in order to create a highly desired state of “flow” for the player. Player input is analyzed by the game program so that it can produce a correct response calculated to produce progressively closer resonance of player-game interaction. The game program correlates variable performance parameters of a player's interaction with the game over time in order to predict player responses to these parameters. The game program then applies its core entrainment principle through time-based dampening with negative feedback in order to continually alter the direction and reduce the magnitude of differences between the player's performance and the game's parameters. The game program uses error-minimization functions to apply the desired resonant response through parameter value combinations which best meet the aforementioned as well as other criteria, such as value balance among parameters. The parameter values best fitting the calculated resonant response are then dynamically adjusted as to game content and/or difficulty, often during real-time game play and even between stages of play in order to generate the structure of successive game content. This cycle is repeated iteratively while the user plays the game.

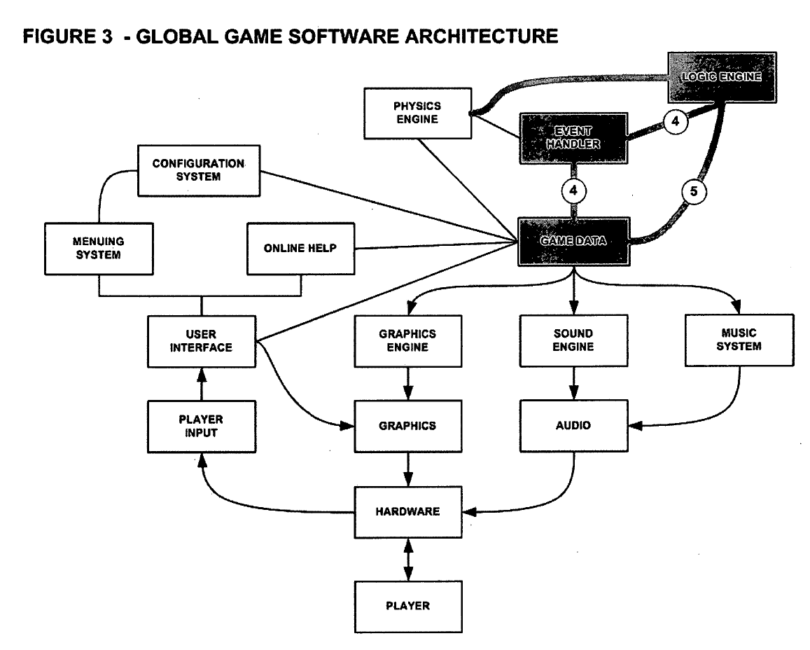

FIG. 3 illustrates the global architecture of typical videogame software. The Logic Engine handles all the game play, enforces the game rules and contains the game's logic schema. The Event Handler controls the generation of the “events” or “scenes” for the game. The Physics Engine enforces rules for simulation of events approximating how they would occur in the real world (lighting, 3D positioning, collisions, changes to model geometries, etc.). The Game Data module stores game resources, such as graphics models (sprites, characters), sounds and music, images, backgrounds and video, and text. This module contains game level descriptions, game status, event queues, user profiles, possible values for each variable program parameter, rules of parameter value compatibility and other miscellaneous information. The other game components communicate with supporting components through this module. The Player provides input through the game Hardware to the User Interface which is retained in the Game Data module, and the game's responses to the Player are generated through various outputs such as a Graphics Engine for generating graphics output, and a Sound Engine and/or a Music Engine for generating audio output. The function and operation of the components of a videogame program are well known to those in this industry and are not described in further detail herein, except where necessary to explain the implementation of the invention.

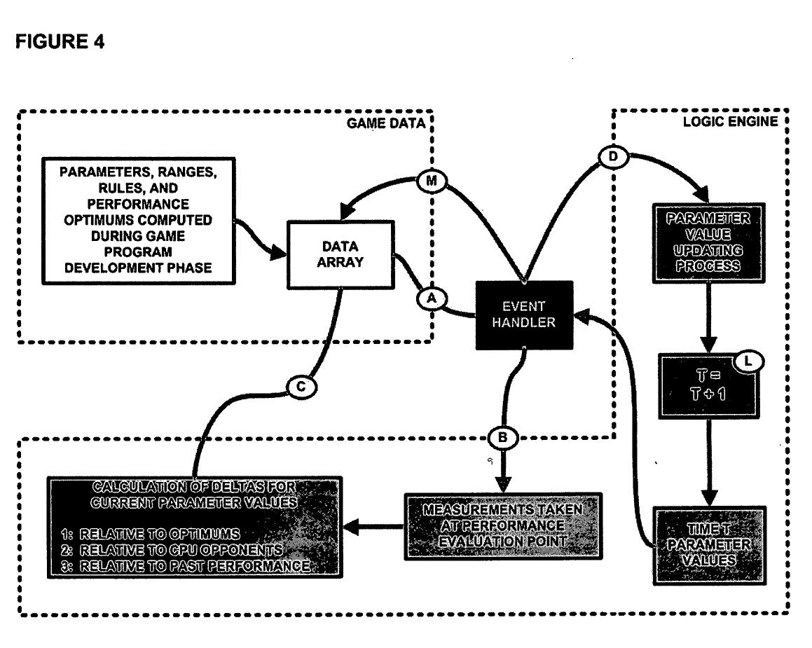

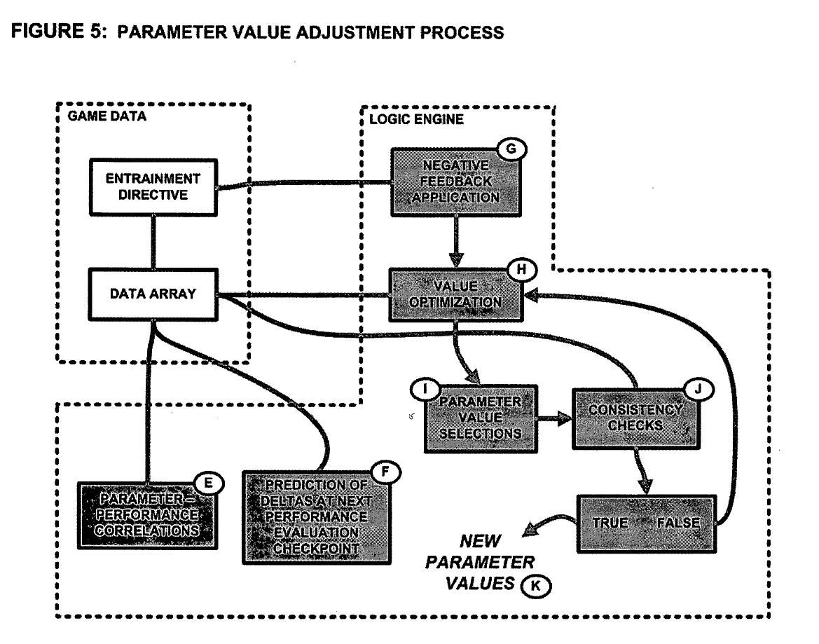

Most videogames games currently use an event-based model, with the Logic Engine changing game status based on events taking place. Events include player input, collisions, and timers controlled by the logic. They are created by the interaction of what are referred to as game tokens, which reference all entities within the game. These tokens have a state and react to and create events. Token interaction matrices are often used to describe the primary behavior of the game as controlled by the Event Handler module. As indicated in the figure, the entrainment process of the present invention is implemented within the Game Data, Logic Engine and Event Handler modules as well as the data flow between them (the data flow numbers refer to the further logic described with respect to FIGS. 4 and 5 below).

FIG. 4 shows the data flow and logic structures for implementing the entrainment process of the present invention in the Game Data and Logic Engine modules with respect to processing control through the Event Handler. As shown in the figure, the Game Data module stores the parameters, ranges, rules for consistency among parameters of the game. It is also used to store the optimum performance times for certain predefined performance parameters such as the player token's speed, skill measures, award accumulation, goal attainment times, etc., which will be used in the entrainment process. Desirable optimums are calculated during the game program's development and testing phases and represent a baseline against which differences (performance “deltas”) in player performance are calculated. When a performance evaluation checkpoint event is reached in the game, the Event Handler in Step A recognizes this event in the Game Data and in Step B directs performance measurements to be taken of both the Player and the program's (CPU-controlled) behavior. Calculations on these measurements are then made to determine player performance relative to: (1) the predetermined optimums; (2) any CPU-controlled opponent(s) and non-player characters; and/or (3) the player's past performance. These delta values are then matched in Step C with the current parameter values or settings, and stored in a Data Array in the Game Data module. The Data Array may be a data table that holds performance values in relationship to time and game parameter settings. The number of values maintained over time T depends on the application, available memory, etc. If the evaluation point is also a parameter update point (a sufficient but not a necessary condition), the Event Handler then initiates in Step D an updating of the parameter values so as to provide a resonant response for entrainment of the player's performance.

As illustrated in FIG. 5, the game parameter value adjustment process proceeds in Step E with the adjustment of the statistical correlation values for the player performance deltas and the program parameter setting values. At each measurement point, the performance deltas are matched in Step C with the settings in effect when these deltas were measured. At each Step E, statistical correlation values which represent the ‘learned’ relationship between program settings values and their respective effects on player performance (in terms of deltas from baseline) are calculated based on all available matched information in the Data Array. Any type of common statistical correlation test (such as a ‘Pearson r’, etc.) may be used to perform this function in Step E. In Step F, a predictive forecast of the player's performance at the next performance evaluation checkpoint may be made based on (1) the ‘learned’ player performance—program parameter correlation values and (2) the settings which will be in effect from the current time to the next performance evaluation point. In many possible implementations of the invention, forecasted player performance based on several settings combinations will be considered in order to determine which settings are optimal for providing a resonant response. Again, any suitable type of statistical predictive method (such as calculating a future value based on a linear trend) may be used to perform this function.

In order to bring the player's performance closer in resonance with current game events, the Logic Engine is now prepared to apply the principle of entrainment by calculating adjustments to be applied to the game parameter values as a form of negative feedback in Step G, which is designed to dampen down the differences between player capability and game difficulty. This is accomplished by the application of progressively smaller negative feedback game responses to player performance over time. Typically, these game parameters are adjusted to create future player performance deltas which are in the opposite mathematical direction from the current ones and are some determined fraction of the current magnitude. This fraction can be a fixed percentage or can itself be a variable parameter, adjusted along with the others in the program.

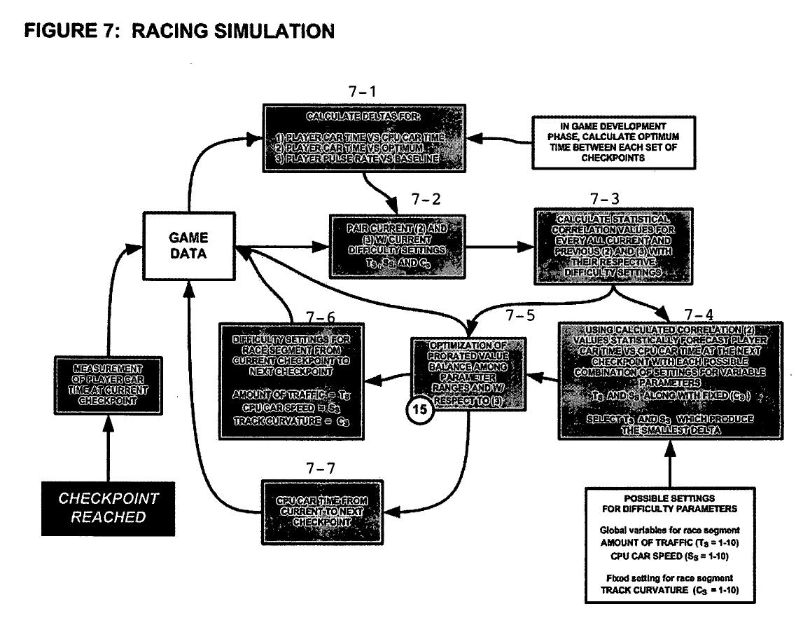

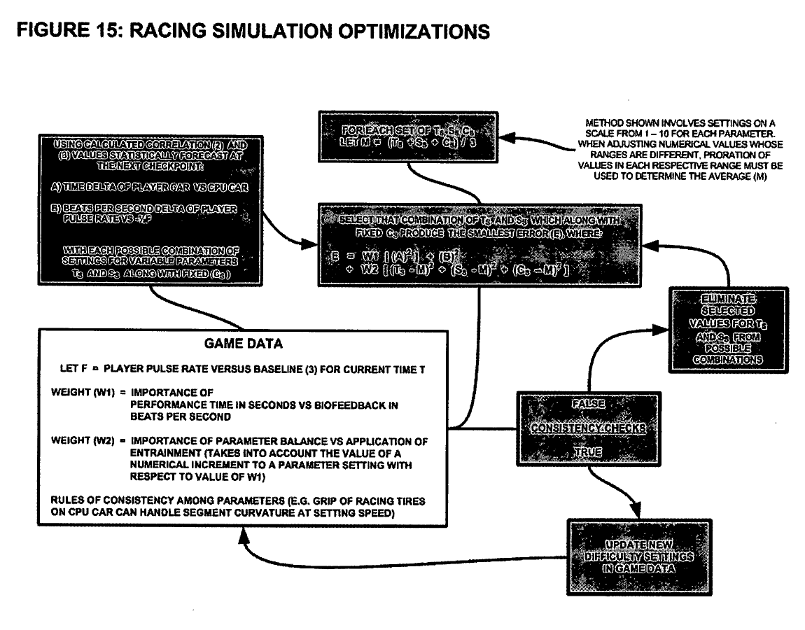

In Step H the adjusted parameter values are optimized to balance the entrainment directive with other parameter value concerns, such as (1) balancing settings values with respect to each other (to provide balance among different aspects of the game) and (2) taking into account multiple performance measurements simultaneously (for example, a player's game goal performance and his biofeedback). Step H can be implemented through any mathematical function which optimizes numerical values through error minimization, for example, minimizing the sum of prorated deviations from an average (see FIGS. 7 and 15 below for an implementation example).

Step I refers to the selection of new game parameter values which are then checked for consistency in Step J, to determine if any mutually exclusive parameter value combinations have been selected. This process accesses the rules of parameter consistency within the data array. If there are no conflicts, the adjusted game parameter values are updated in Step K, at which point they are directed to either the Game Data module and/or the Physics Engine for actual generation of the next set of game responses.

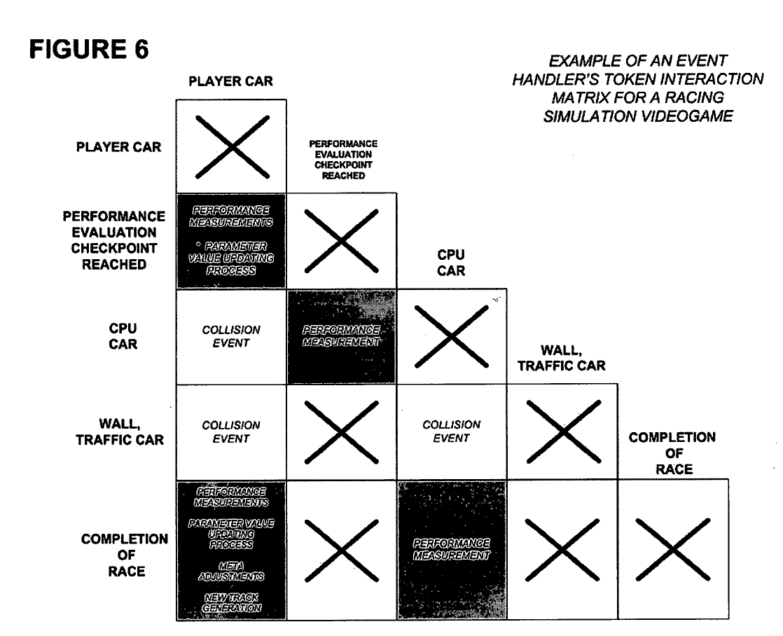

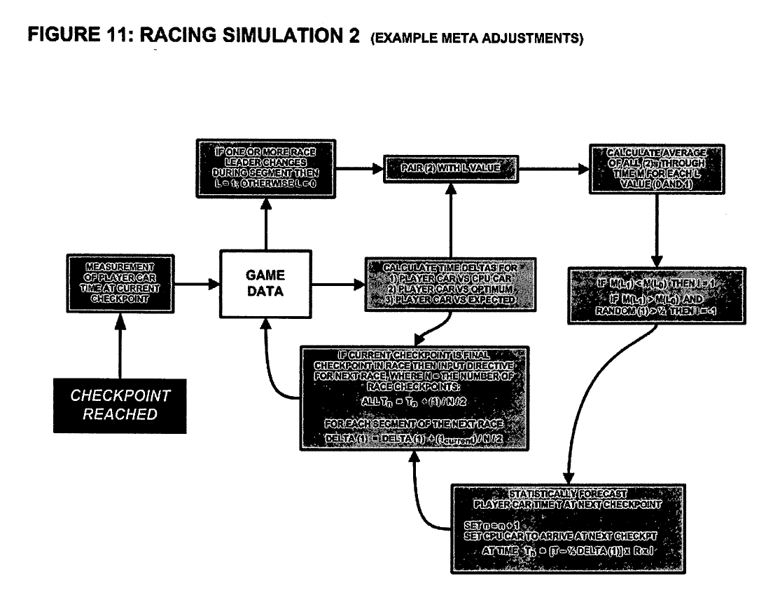

In FIG. 6, an example is given of an Event Handler's token interaction matrix for a simple car racing simulation videogame. As illustrated, the shaded interaction regions represent events intrinsic to the entrainment method of the present invention. When the player's car reaches a performance evaluation checkpoint, the Event Handler reads this event from the Game Data (Step A in FIG. 4), measures (Step B in FIG. 4) the player's performance (e.g., time of arrival at the current measurement point), and calculates and records the deltas for the current parameter values (Step C in FIG. 4). If the evaluation point is also a parameter update point, then the Event Handler initiates the parameter value updating process (Steps D to M in FIGS. 4 and 5). In cases where the coordinates of the CPU-controlled car(s) that the player is racing against are not predetermined, the Event Handler must also record the time of arrival for each CPU-controlled car as it reaches the performance evaluation point respectively. If a collision of the CPU-controlled car and the player's car with a wall is scheduled in the Game Data, these race events are triggered in the Event Handler matrix. The completion of this race segment can also trigger a performance measurement and parameter value update process (for the variables of the next race segment), meta adjustments such as adjusting the negative feedback application rate (for propensity of racer lead changes), and/or the generation of new game content such as a new track segment whose design is also a function of the optimized entrainment process. See FIGS. 11, 13, and 14 for implementation examples of meta-adjustments and content generation.

In FIG. 7, a flowchart illustrates an example of how the game parameter values (difficulty settings) of variable game parameters (Track Curvature C, CPU Car Speed S, and Amount of Traffic T) are adjusted to progressively balance game difficulty with player performance over time. A performance evaluation checkpoint is reached and measurements for the player's car are taken at the current checkpoint and provided to the Game Data. In Step 7-1 the game program calculates deltas for certain specified performance values: (1) the player car time vs CPU car time, (2) player car time vs optimum time (determined in the game development phase), and/or (3) player physiological input (pulse rate) vs baseline pulse rate. In Step 7-2 one or more of the calculated deltas may be compared with the current difficulty settings (T, S, C), and statistical correlation values are calculated between the performance deltas and the difficulty settings in Step 7-3. In Step 7-4 the calculated correlation values may be used to forecast the player's performance (time vs CPU car time) at the next checkpoint. In Step 7-5 the calculated correlation values and/or the forecast of the player's next performance time are used to calculate optimized values for a desired level of balance of game difficulty with player performance over time. In Step 7-6 the optimized values are used to determine the new difficulty settings (T, S, C) for the next race segment from the current checkpoint to the next checkpoint and, correspondingly in Step 7-7, the CPU car time from the current checkpoint to the next checkpoint.

In this example, each parameter setting can have simple step values from 1-10, corresponding to gradations of ‘novice’, ‘easy’, ‘medium’, ‘hard’, etc. The game program's application of the dampening principle (altering of direction and decreasing of magnitude of deltas) is progressive by default. Since this is a prediction, there will generally be error, and since there is no inherent bias, the errors through time will average positive 50% and negative 50%, thus the altering of the direction of the performance trend of the player car relative to the CPU opponent. The magnitude of the adjustments is progressively decreased as the statistical predictions, made by a common statistical forecast function, will become more accurate through time as more data becomes available from which to make them.

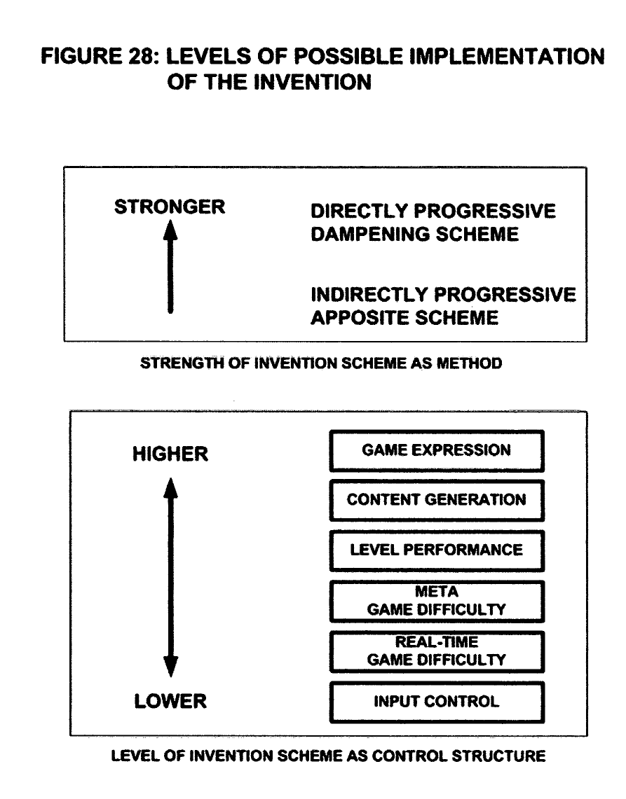

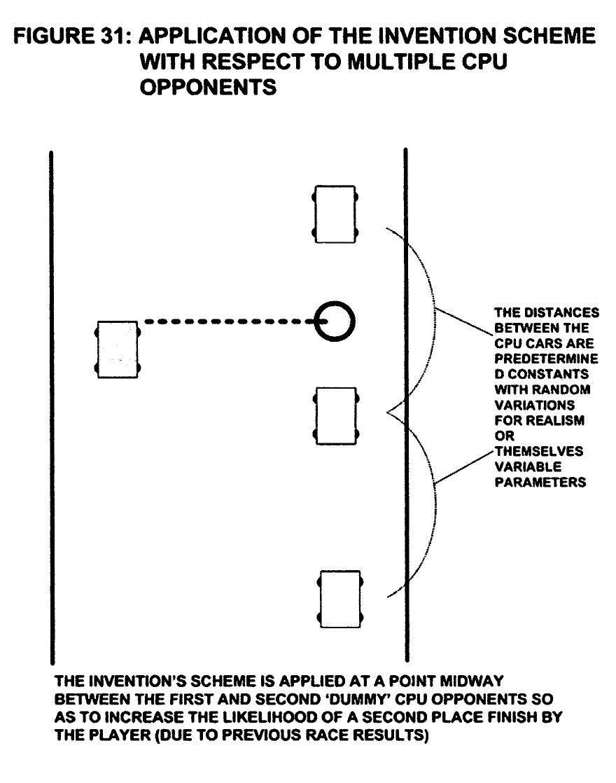

While the application of the invention with simultaneous multiple CPU opponents in some games and genres are not applicable, providing the ivention scheme with multiple opponents does not prohibit the underlying concept, but each respective implementation would require additional application rules, which could be quite diverse. For example, if the game contains 3 CPU opponents and is based on through-time player performance relative to optimums, the correct application of the invention scheme with respect to player finishing position for the current race is second then a fixed position could represent the scheme's application while an additional algorithm is implemented to control the separation of three ‘dummy’ cars. Their relative spacing might be governed using constant separation distance values along with random variations for increased realism. In this example, the position midway between the first (fastest) dummy car and the second ‘dummy’ CPU car would run according to the invention scheme. In this manner, the player is effectively playing against the 2^{nd} place race position (see FIG. 31), which is the goal of the invention scheme at the race result level. The player may finish 2^{nd} in the race, or may beat the first place dummy car by completely outperforming the invention's scheme, or may finish last in the race by performing unexpectedly poorly during the last race segment (on which there are no more adjustments made). However, the invention will work through time and the odds are in this case that the player will finish second which is the desired result to apply the invention scheme at the ‘race result’ performance level which lies above the ‘meta-difficulty’ level (see FIG. 28 and discussion of different implementation levels).

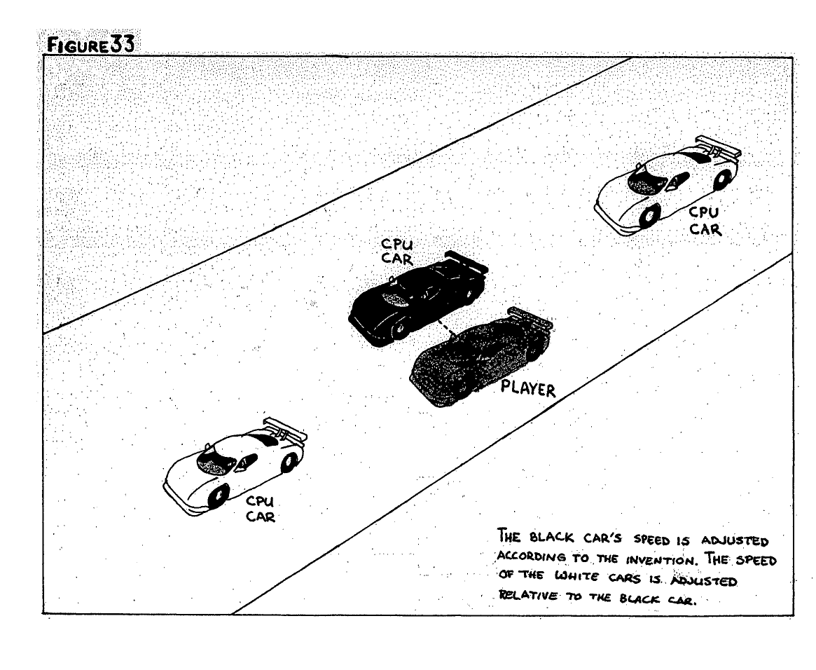

With biofeedback input, additional race position shifting could occur. For example, if the player's pulse rate dropped while his performance delta versus optimum time also dropped for 2 consecutive race segments, the method's ‘fixed spot’ could progress to the lead position, or even ahead of it, thus rewarding certain combinations of player performance aspects. The line between player performance level implementation and meta adjustment level implementation (see FIG. 11) is a continuum, the former referring to stronger application methods since it is implemented from a higher level control structure. FIG. 33 illustrates a similar situation except that the desired finishing result to apply the invention scheme at the ‘race result’ player performance level is either 2^{nd} or 3^{rd} place.

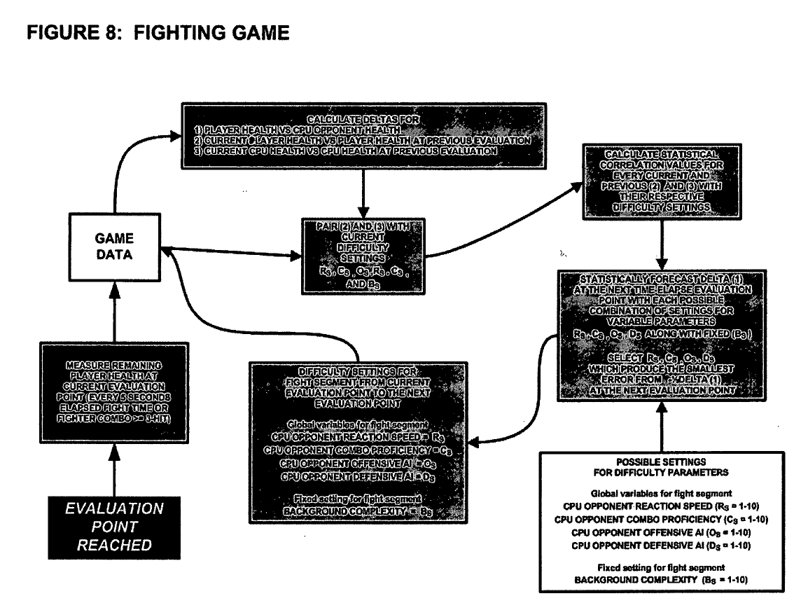

In FIG. 8, the difficulty parameter adjustment process is applied to a fighting-based videogame instead of the racing simulation in FIG. 7. The game difficulty parameters are different and the dampening scheme is applied directly rather than indirectly. In this case, the player performance evaluation point is taken at every 5 seconds of elapsed fight time as well as at every in-game event in which either fighter, player or non-player character (NPC), executes a successful attack combination of 3 hits or more. The reason for both is to provide a similar scheme regardless of combat speed or fighter proficiency. With a shorter time-elapse value, the event-based evaluations would not be necessary. It is not shown in the figure, but the time-elapse counter begins again after a 3+ hit combo-event. Again, in this example, there is one parameter with a fixed value, in this case the fighting arena's BACKGROUND COMPLEXITY. Again it will be correlated with player performance, but the arena is fixed during the course of the fight. Characteristics of the arena and its animations could be added as variable parameters to be adjusted during real-time play, but in this example is used as a constant setting during the course of the fight. The variable parameters in this case all refer to the CPU opponent: REACTION SPEED, COMBO PROFICIENCY, OFFENSIVE AI, and DEFENSIVE AI. The choice of representing the CPU opponent AI was made in order to illustrate that the Invention can be considered as the AI itself or as a higher level control structure which selects which level of AI (itself referring to many individual parameters) to be applied. The dampening scheme is applied directly as the game program measures the difference in the remaining health of both fighters at the current evaluation point. It then forecasts the player's remaining health at the next time-elapse performance evaluation point with all possible combinations of variable settings and selects the settings which most closely forecast the CPU opponent's health at a relative point to the player fighter's health representing −½ the current measured difference. The negative sign alters the direction of the performance trend (which fighter is winning) and the constant iterative damping value of ½ reduces the magnitude of the difference. The iterative value is this example is constant but could also be a dynamic and progressive function of player performance, measured by delta (3) in the figure, and/or game presentation variables through time.

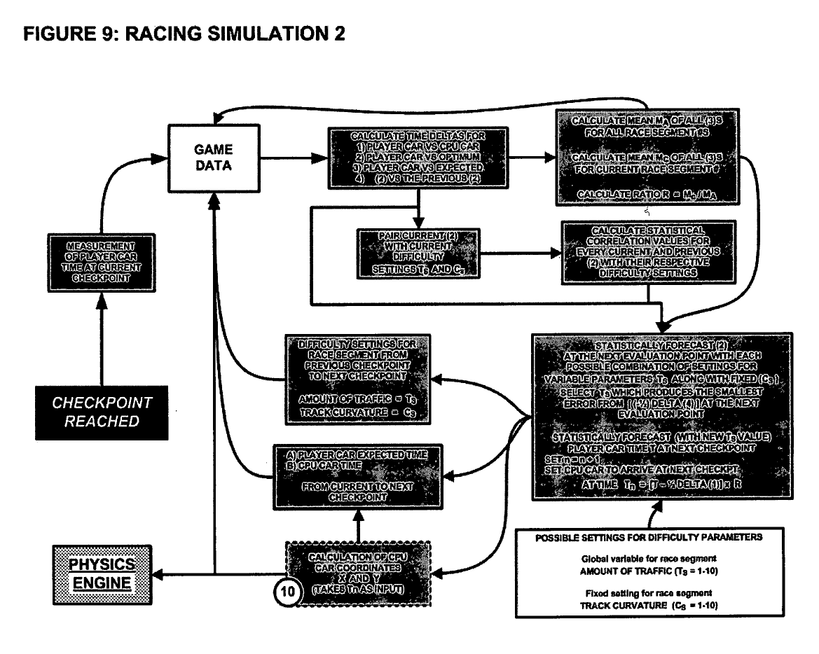

FIG. 9 illustrates an implementation similar to FIG. 7, again in a racing simulation game. There are many differences in Invention structure. Now, only one variable parameter (AMOUNT OF TRAFFIC) is adjusted through predefined settings and by a system which adjusts the parameter based on through-time player performance. The program forecasts the player car time versus the optimum time for the next race segment for each possible setting for AMOUNT OF TRAFFIC. It then selects a setting for AMOUNT OF TRAFFIC that applies the negative feedback dampening scheme (again with a reduction factor of ½) relative to the player's through-time performance over the last two race segments. For example, if the last race segment was a completed with a delta from optimum A and the one before it with a delta from optimum B, the program will adjust the setting for AMOUNT OF TRAFFIC so that the next segment's predicted delta from optimum is the average of A and B. Like FIG. 7, one parameter with predefined settings (TRACK CURVATURE) remains constant. The CPU CAR SPEED parameter is controlled in real-time through adjustments to numerical X and Y coordinate values which correspond to specific track positions. This type of dynamic adjustment to numerical values rather than simply predetermined ‘sets’ of parameter values has many advantages. In the case of narrative-based games or even settings which refer to predetermined animation sequences of model geometries, as the number of parameter adjustment points increases, so does the number of sequences that would have to be pre-scripted. At a high enough number of adjustment points, this type of system is longer be practical to implement.

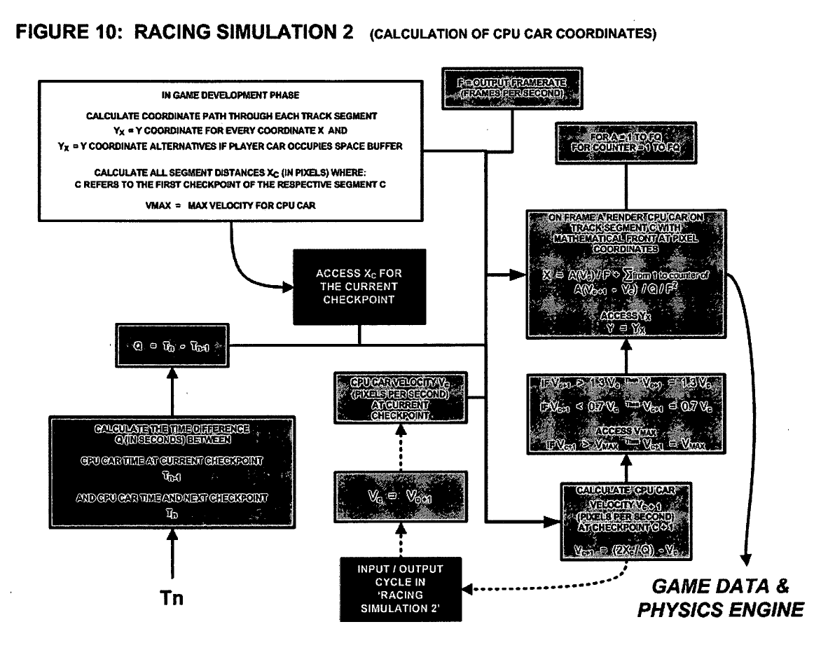

In FIGS. 9 and 10 the CPU car's velocity is adjusted to smoothly transition from the ending velocity and position of the last segment starting velocity and initial position of the current segment) to reach the next checkpoint (terminal position) at the desired time based on real-time calculation of a CPU car velocity along a traditional pre-scripted or dynamically generated interpolation path (player car behavior can alter this path). In this example, like FIG. 8, this desired time, within limits of realism, corresponds to ½ the time difference (delta) of the arrival of the respective cars at the current checkpoint and furthermore corresponds to the CPU CAR being on the opposite side of the player car than at the current checkpoint (e.g. if behind, now ahead; if ahead, now behind). The specific process of calculating the X and Y values for the CPU car for each frame of the next segment in real-time is provided in FIG. 10. The global parameter Tₙ is fed into this subroutine, which makes calculations based on local parameters (and some data accessed from files created in the game's development phase) to finally output and pass through the global parameters X and Y back to game data to be read by the physics engine and/or to the physics engine itself. Additionally, as shown in FIG. 9, the CPU CAR SPEED (which ultimately results in coordinates and an interpolated velocity path) is further weighted based on tendencies in track segments which refer to confounding variables, such as a player waiting until a certain segment to play his best. This process is one of many likely to be used to keep players from taking advantage of the feedback-based opponent scheme. The average performance relative to predicted or expected performance on all segments for all races through time is continually calculated and stored in game data.

The current segment #'s (such as segment 4 of 10) deviation from the average weights itself through time and is applied as the ‘R’ value indicated in FIG. 9 to modify the CPU opponent's velocity so as to account for consistent deviations from expectations for one or more segments. This process can be applied over many races and/or in multiple lap races to help limit the effect of unknown ‘confounding’ variables and work linearly against ‘unfair’ player deviations such as the one mentioned above. For multiple race concerns, if races are constructed with differing numbers of segments, a prorating system can be used. Another method that could be implemented to limit ‘unfair’ player deviations would be to increase the dampening magnitude relative to player performance when the performance is lower than the expectation. More data on player consistency could be kept and analyzed from which reasonable determinations of ‘unfair’ or even ‘lazy’ player behavior could be counteracted through additional methods. This process will work linearly against ‘unfair’ player deviations and also take effect within a single race with multiple laps or through time in general to control other confounding variables besides the deliberate one mentioned above. For multiple race concerns, if races are constructed with differing numbers of segments, a prorating system can be used.

FIG. 10 also indicates some additional realism ‘boundaries’ on the CPU car's segment velocity. In order to provide the Invention's scheme so that the CPU CAR behaves in a more realistic way and provides the Invention's scheme relatively transparently to the player (both would be necessary in a marketable game), certain constraints should be applied. In this example, two such constraints are applied as the CPU CAR is not allowed to alter its velocity by more than 30% during any given race segment and is not allowed to exceed its maximum velocity. As is shown on the flowchart, these constraints override the Invention's primary entrainment directive. With these constraints applied, it may take more than one race segment for the CPU car to make the correct adjustment (of course each successive adjustment directive will override the last). In a marketable modern videogame, these concerns (not intrinsic to the Invention structure) would be more extensive, allowing for speed on turns versus grip of tires, acceleration rates per engine, and so forth.

FIG. 11 illustrates two further additions augmenting the example shown in FIG. 9. These adjustments are labeled as meta adjustments in the figure, as they fall outside the core negative feedback cycle. One addition takes into account the effect of lead changes on player performance. For example, with a high number of adjustment points, it may be distracting for the player to have the race leader change so frequently. The example shows how the measurement and correlated effect of lead changes on player performance can be used to adjust a probability factor of a lead change during the upcoming race segment. If player performance versus optimums through time are better when there are no lead changes, then the calculated time Tₙ for the CPU car to reach the next checkpoint is made to still apply the decrease in magnitude of the current delta in all cases (again by a factor of ½) but the likelihood of the alteration of the performance trend (lead change) is reduced by 50% (a factor which could be made dynamic as well). This is like a ‘dampened’ dampening based on the effects of the dampening procedure.

FIG. 11 also indicates the application of the dampening scheme outside of in-race adjustments. Based on the player's performance on the previous race as a whole (e.g. win or loss) the game program weights the CPU CAR SPEED to prorate ½ the player car versus CPU car delta on the finishing segment of the previous race through the segments of the next race. For example, if the player won the last race by 5 seconds and there are 10 race segments in the next race, then each of the CPU car's Tₙ times in the next race will be adjusted less (faster) by ¼ of a second in order to place the CPU car ahead of the player car at the end of the next race by 2.5 seconds. If the player lost the last race, then the CPU car will expect to lose the next one by half the time difference of the current player loss. As is shown in FIG. 11, this augmentation also requires the directive that the delta (1) calculations for the next race be weighted as well, so the core segment to segment interaction scheme doesn't override this higher level directive. This example was provided to illustrate that the dampening method can be implemented at several performance ‘levels’ such as being ahead in a fight, winning a battle, or winning a war (using military strategy game allusions). It should be noted here that in this case or if there are multiple CPU opponents in the race, this system can be implemented with some additional instructions so as to provide a particular distribution to player results, even a distribution based on (so as to further optimize) player performance through time. It might be best if for every win, there are two place finishes and one third and so on and so forth.

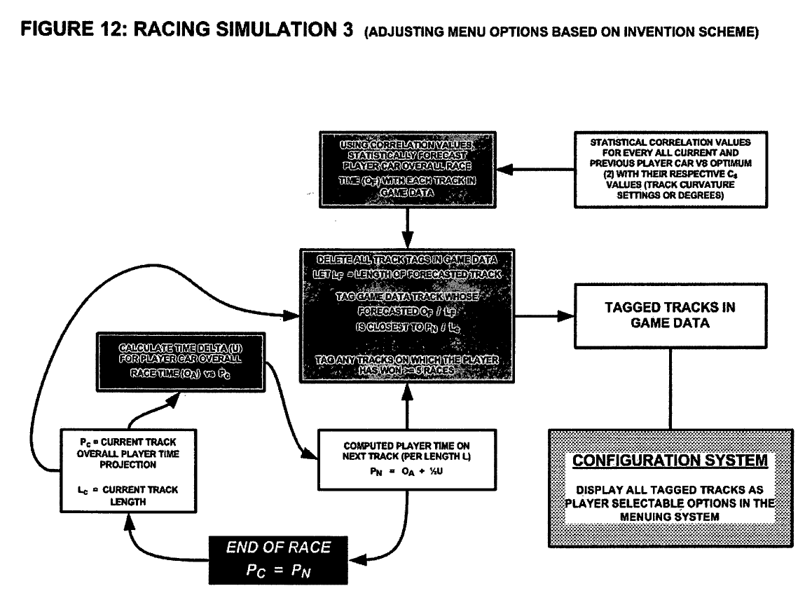

FIG. 12 shows an implementation to adjust the options available to the player in the menuing system. This is accomplished by tagging the appropriate track in game data so the configuration system can provide that track as an option in a game menu. This example implementation is essentially selecting the next track for the player, except that a condition has been added to allow any tracks on which the player has won five or more times to also be tagged in game data and selectable by the player. Again with a racing simulation videogame, the available race tracks from which the player can select is directed by the game program based on a dampening effect relative to player performance on the last track. The overall curvature of the race segments is effectively increased or decreased based on whether the player performs respectively better or worse than the projected race time (sum of individual segment projections). The projection, of course, is a result of and thus represents the player's past performance. The player's overall race time on the last track is measured and a delta is calculated relative to the projected time. This projected time is compiled as the sum of all segment projections made at each performance evaluation point along with the projection made at the beginning of the race for the first segment. The optimum time per unit track length to implement the Invention scheme is now computed as the player race time per unit length on the previous track plus ½ the above calculated delta (the ‘plus’ works in both directions as the delta is negative if the player's performance was better than the projection). The game program now uses all track-related parameter-performance correlations (in this case just CURVATURE OF TRACK C_{S}) in order to select that track from all those available in game data (including the current one) whose forecasted player performance time O_{F} per unit length L_{F} is the closest to the optimum time per unit length computed above P_{N}/L_{C}. All existing tags in game data are erased and the selected track is tagged (along with tracks on which the player has won 5 or more races).

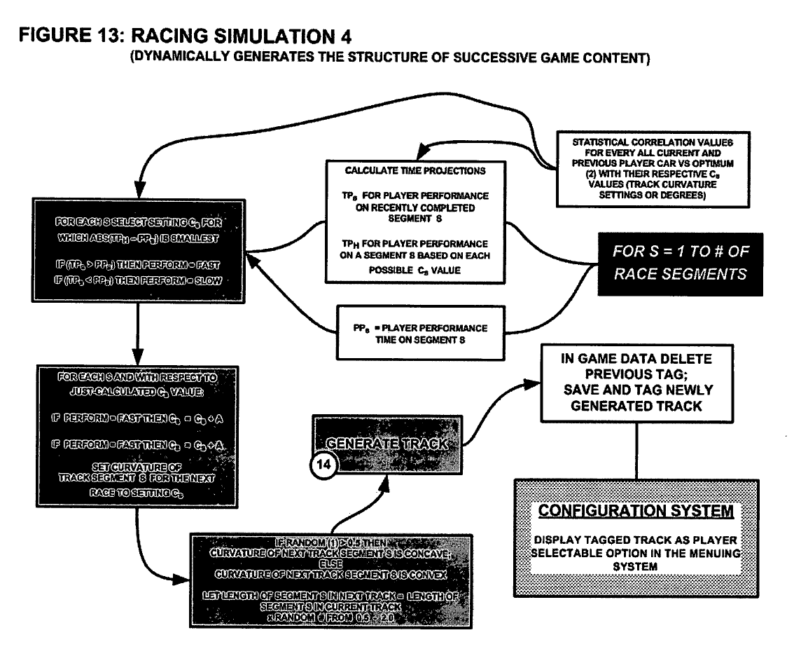

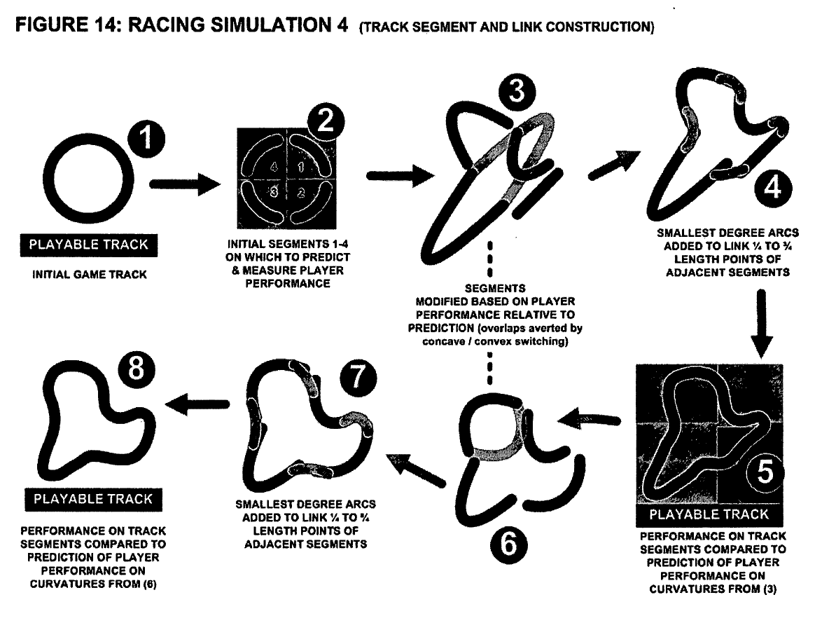

FIGS. 13 and 14 go a step further than FIG. 12, by actually generating the structure of the next race track after the completion of the previous one. This allows for each successive track to be optimal for the application of the progressive dampening scheme (player capability relative to game difficulty), rather than simply selecting the ‘best’ choice from premodeled tracks. This can be applied not only during game play stages (such as a race or fight), but each successive stage can be generated to provide the dampening scheme with respect to the last, which will advance the overall progressive nature of the application exponentially. The flowchart in FIG. 13 indicates that for each segment of the current race, the following process occurs, and when the race is finished, the next track is constructed as shown in FIG. 14. For each race segment S, the game program measures the player's performance time on the segment (this application can be implemented with other performance aspects such as the biofeedback mentioned earlier) and then finds and selects a matching segment curvature in game data for which a new player projected time (on updated correlation and prediction data) on that curvature is the closest to the player performance time on the segment S just completed. This matching segment curvature can be an actual track segment, premodeled like the tracks in the example in FIG. 12, or the game program can plot a graph of the player's performance relative to curvature and then create (model in real-time) the optimal curvature specifically. This second application is much more powerful (but more complex to implement in the physics and graphics engines), but is no longer limited to approximations to the optimal selection.

Now the negative feedback dampening scheme is applied. At this point depending on whether the player performed better or worse than the old projection on the last race segment S, the game program adjusts the optimal selected curvature up or down respectively by some amount A. If the program is limited to premodeled segments, then the curvature of next higher or lower difficulty is selected. If the program is modeling segments in real time based on optimal numerical values of curvatures, the magnitude A corresponds to some value between 0 and the delta between TP_{S} and PP_{S}, which is the difference between the projected and actual player race times on the segment S just completed. This dampening iteration value can be a dynamic variable through time as mentioned previously, or can again be some constant value such as ½. This final calculated curvature which will represent segment S in the next race. The game program then randomly selects whether the curvature should be concave or convex (the direction of the turn relative to the initial point on the segment) and if the curvatures are being created in real time, randomly selects its length to be of some random value between one-half to twice the length of segment S just completed. This data is now sent to the dynamic track generation system illustrated in FIG. 14, after which the new track is tagged in game data and the only one selectable in the menu as directed by the configuration system.

FIG. 14 shows the process of dynamically creating a new racetrack according to previous player performance. It is primarily illustrated as one of many possible methods that could be used in order to implement the invention for the generation of new program content through time. FIG. 14 shows the construction process of the track segments and the linking segments between them. As shown in step 2, player performance is measured on each segment of an existing track during real-time play. At this point each segment S is separately modified based on player performance relative to the projection of player performance, as described in the above paragraph. The new segment curvatures and lengths are laid down in order as shown in step 3, and if any overlapping occurs (whether in 2 dimensions or 3), the later number segment's concave curvature is switched to convex to avoid the overlap. Now, as illustrated in step 4, a connecting section between each segment is laid down in order to bridge the segments as smoothly as possible. These connecting sections attach to the end of each segment and to the beginning of the next at points ¼ the length of the original segments into each segment. This process uses a simple optimization function (minimizing error from squared deviations of each point on the section's curvature from a zero-point curvature) to transform the linking sections into the smallest overall degree curvature arc possible. At this point the excess ¼'s are cut off from the primary segments and the new track is complete as shown in step 5. This playable track starts the process over again as player performance is measured and the next track is generated in the same manner (steps 6-8).

While this example has shown a process by which the Invention can be applied to new track content generation in 2 dimensions, it is equally applicable in 3 dimensions. Rather than just correlating the effect of one parameter on player performance time (TRACK CURVATURE C_{S}), another can be added (such as TRACK HEIGHT H_{S} which represents the difference in vertical dimension between the initial and terminal positions of each segment S). Various combinations of height and curvature will lead to various banking in the track, etc. which will have measurable effects on player performance times. Two variable parameters can be implemented into the process shown in FIG. 13. Additionally, this type of process could be done with optimization functions which optimize the Invention's response scheme with respect to two different performance aspects of the game such as those described in FIG. 15. The general selection and generation process described in FIGS. 13 and 14 can also be applied to other elements and games, such as the characteristics of a fighting arena, the next narrative sequence in a role playing game, new battlefields in strategy games and new multiplayer arenas in the first person shooter genre.

FIG. 15 illustrates the use of optimization functions in order to handle two important game concerns which are a result of the Invention implementation scheme. The first of these has to do with games having multiple aspects of performance (e.g. in a first person shooter game, not just how far the player has the player progressed on a level, but how many enemies has he killed, what is his current health status, etc.). Referring to the first implementation example in the racing simulation videogame in FIG. 7, two aspects of player performance are measured, racing time per segment versus optimum or baseline (in seconds) and player pulse rate versus starting baseline (in beats per second). The first optimization function shown in FIG. 15 allows the game program to apply the negative feedback dampening scheme, with respect to both aspects of performance, with relative balance between them. A weighting value is used in this case which represents the importance of the racing time aspect versus the biofeedback aspect. This value ‘W1’ can be a constant (such as 3) determined in the development phase or a variable parameter driven by some through-time player performance trend based on the effects of both aspects. This part of the optimization function respectively sums the squares of the relative deviations from the forecasted CPU car time at the next evaluation point and −½ of the player pulse rate delta versus baseline at the current evaluation point.

The second part of the optimization function balances the variable parameter settings T_{S}, S_{S}, and C_{S} with respect to one another (e.g. settings of 4, 5, 5 are more balanced than settings 1, 6, 10). This is accomplished by first calculating an average of the settings for each possible combination and then employing the second part of the optimization function. This second part of the function is also weighted (by W2), in this case with respect to the importance of parameter balance with the application of the Invention's negative feedback dampening scheme. In this case, the value of W2 is also relative to the value of W1, so optimization is proportionally correct. The second part of the optimization function sums the squares of the relative deviations of each parameter value from the average of the respective set. The optimization function is implemented by finding that set of parameter values which satisfies all the above conditions with the smallest numerical error. At this point, based on rules of consistency among parameter values (for example, a curvature of level 10 and CPU car speed of level 10 might not be compatible), consistency checks are performed based on the final selected set of parameter values. If they are determined wholly consistent then the new values are updated in game data; if they are not, the set of values producing the next smallest amount of error in the optimization function is selected and checked for consistency. This process continues until a consistent set is found. This method of consistency checking may be more processor-intensive than others which may be implemented as well, such as only allowing combinations that are consistent into the optimization routine in the first place. The method described above involves settings on a scale from 1-10 for each parameter. If it is necessary to adjust numerical values with different (or seemingly unrelated) ranges, proration of values in each respective range must be used to determine the average (M) in each respective case.

### DETAILED EXAMPLES OF APPOSITE PARAMETER ADJUSTMENT EMBODIMENT

As an alternative to adjusting parameters based on the directly progressive negative feedback dampening process, the invention can be implemented in a weaker form by selection of apposite predetermined values. This type of scheme selects the appropriate setting for each parameter based on current user performance and does not do so based on delta trends in user performance as shown in the previous examples, therefore it does not anticipate, predict, or plan for future trends. This type of application is still providing negative feedback, in that the difficulty of the game will be increased as the player performs better and the difficulty will be decreased as he performs worse. An apposite embodiment may adjust parameters so as to dampen the difference between player capability and game program challenge through time, as a more balanced game will naturally lead to a progressively better player-program interaction through time, which will result in increasing refinement of balance. However, the progressive nature in the apposite scheme is not as direct as a specifically-applied dampening scheme. Although it may be a weaker application of negative feedback than the full progressive scheme, it may be more appropriate to use initially before trends in player performance have acquired the necessary statistical confidence intervals to be more effective. Additionally, this apposite scheme may be easier to implement within existing game architectures.

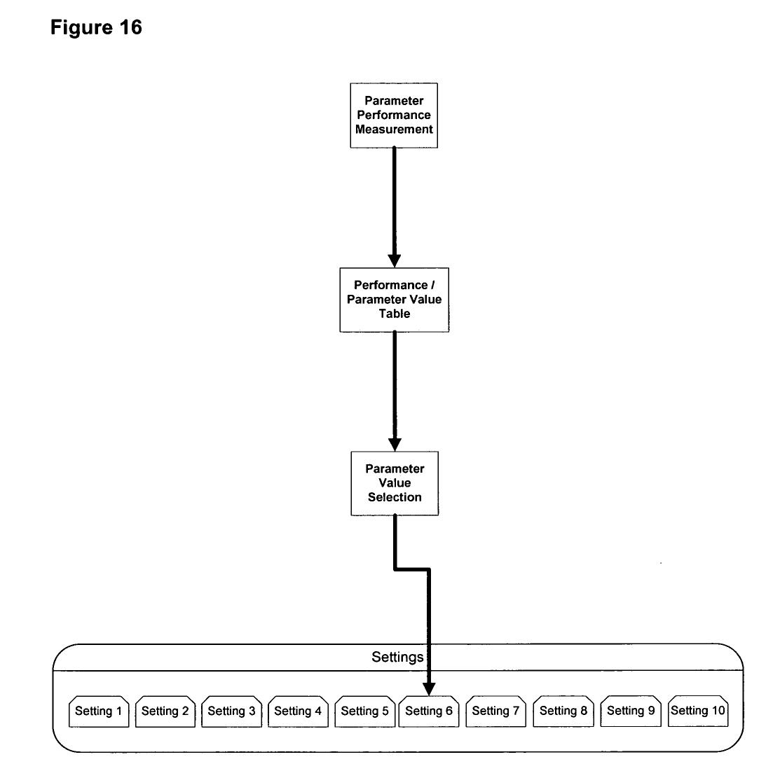

Referring to FIG. 16 illustrating an example of the logic of apposite parameter adjustment, the game developers first determine which program performance levels should refer to which settings, so that the response to particular performance measurements can be used to adjust the settings accordingly. A table of performance measurements and associated settings is created in the program testing phase and simply referenced by the control structure in order to select the correct setting following performance evaluation.

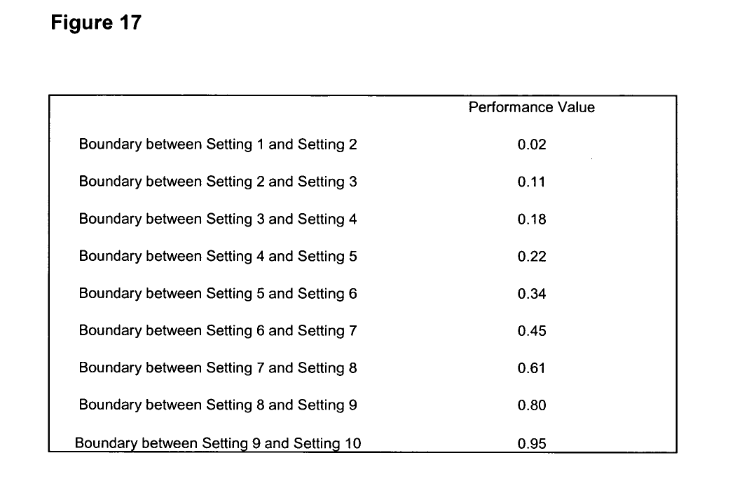

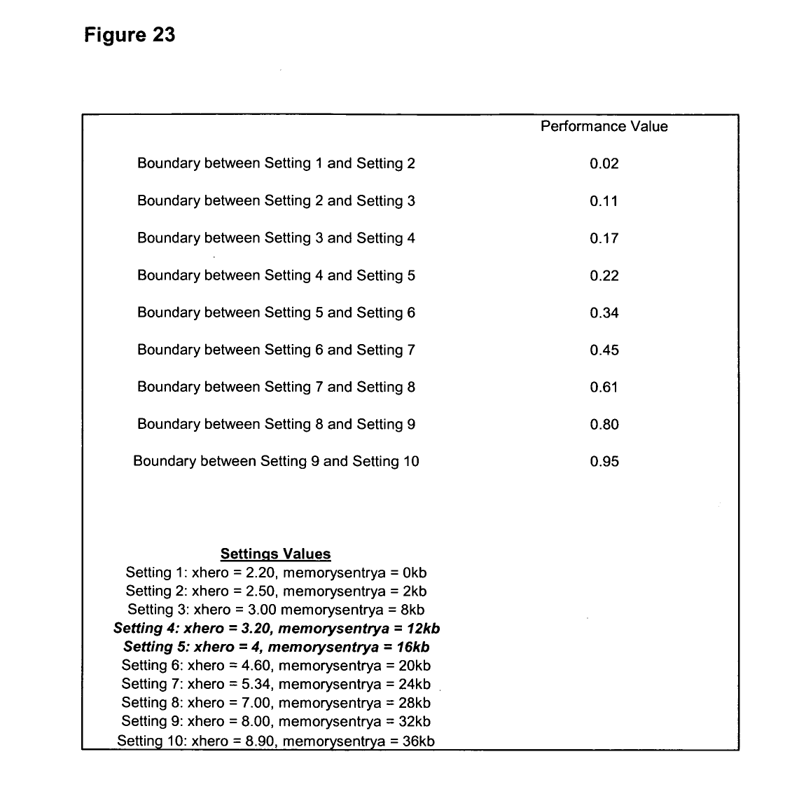

FIG. 17 shows an example of a table of hypothetical performance values relating to 9 measurable performance boundaries in a program which correspond to 10 distinct hypothetical parameter settings. The performance values could refer to a user's entire lap times, transparent or displayed checkpoint (lap section) times, pulse rate, typing speed or ratio of remaining player health to that of a computer opponent. The parameter settings could refer to general difficulty settings (such as very easy, easy, novice, medium, . . . extremely hard) which correspond to many individual program parameters tested for balance and consistency. The settings could also refer to individual parameters themselves, such as velocity of the vehicle #3 computer opponent in a racing simulation, display frequency of the automated assistant in a word processing program, average combo length of a computer opponent in a fighting game, or the amount of volatile memory allotted to a player's trail in a stealth mission game which could be picked up by an enemy. In a real table used in a program, each of these settings would refer to one or more specific parameter values, such as variable xₕₑᵣₒ=3.20 or memory_{sentrya}=12 kb (more in FIG. 23).

A binary search is performed on the table's column of performance values to determine which table values boundary the user's measured performance. The respective setting is then selected. For example, if the user's measured performance value is less than 0.02 then Setting 1 is selected; if the user's measured performance value is 0.29, then Setting 5 is selected. In this example, if the measurement falls on a boundary, the setting is rounded down.

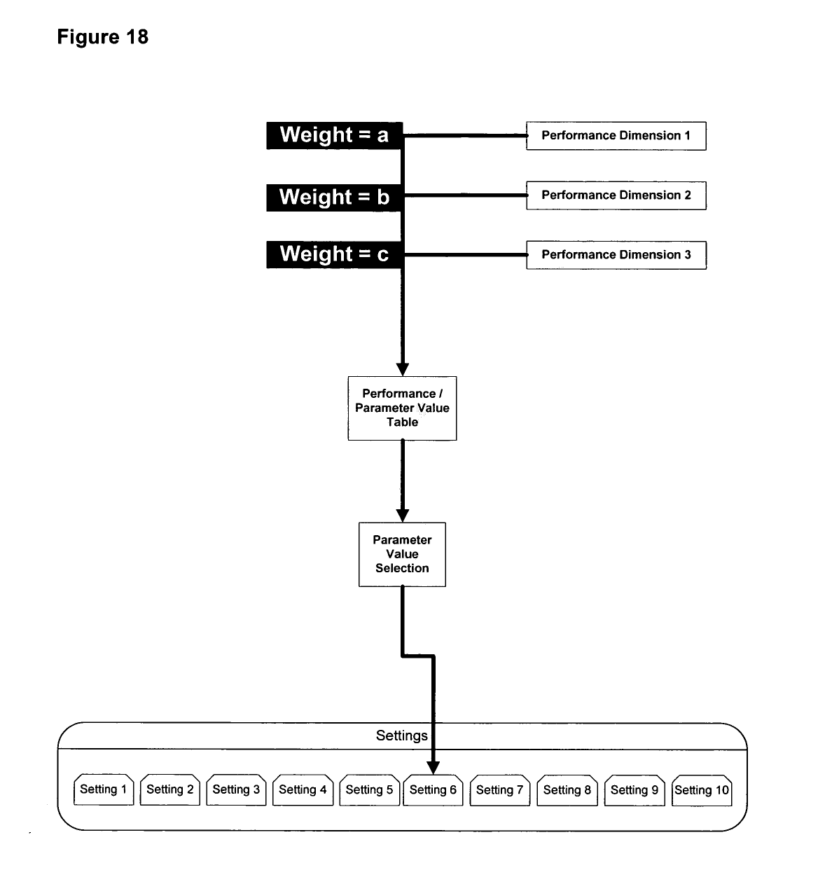

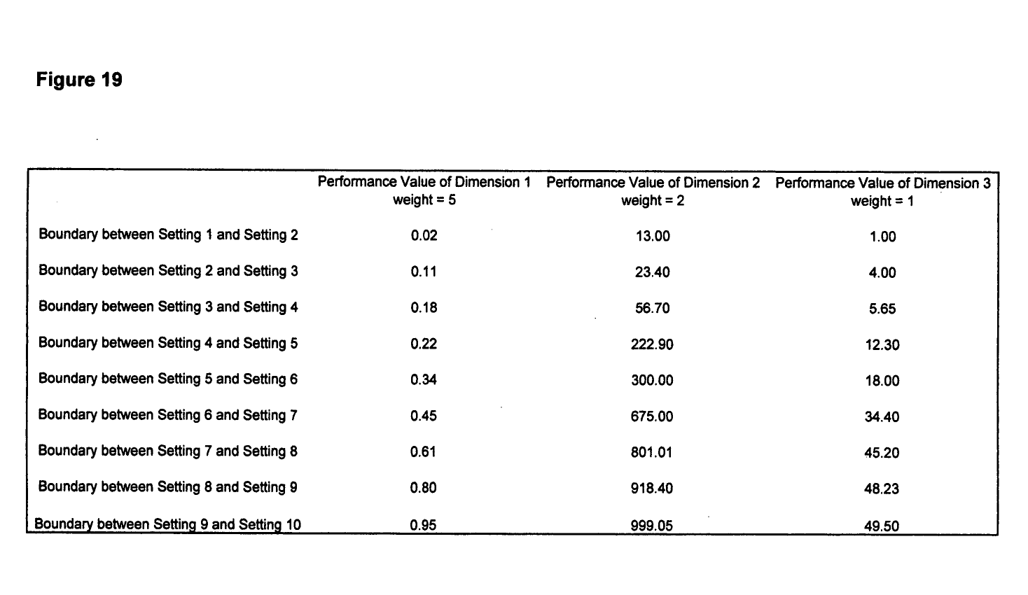

In a sufficiently large and/or complex program, each individual parameter or setting (group of parameter values) may be adjusted based on several simultaneous but distinctly different user performance measurements. For example, in a large racing game, lap time is probably not the only determinant of difficulty. Position in the race, amount of damage the player's car has taken, etc., all have an effect on the difficulty setting. In a word processing program, the degree to which the user has completed obvious goals, his pulse rate, and typing speed all have an effect on settings. FIGS. 18 and 19 are similar to FIGS. 16 and 17 except that there are now three dimensions of performance being measured (perhaps but not necessarily simultaneously). Each dimension of performance measurement will correspond to one of the settings. If they do not all correspond to the same setting, then an average must be taken. This can be done in many ways, depending on the program, and should be left to the program developer to determine. An example might be, however, that each performance dimension has a weight, as indicated in FIG. 19, according to how important that particular performance dimension is to the parameter setting. Measurement of Dimension 1 may relate to Setting 1, while Dimension 2 relates to Setting 6, and Dimension 3 relates to Setting 7. In this case, an average can be taken:
[1×(5)]+[6×(2)]+[7×(1)]/(8)=24/8=3

In this case, setting 3 would be selected. In most cases, the average would not be an exact whole number, in which case, rounding up or down may be necessary. It may even be determined that the exact proportional location within a Setting range of a dimensional performance measurement may be taken into account before the averaging process, such as is the performance measurement for Dimension 1 close to the boundary between Setting 1 and Setting 2, is the measurement for Dimension 3 “35.00” or “44.20” and so forth.

When dealing with individual parameter adjustments, each individual parameter's adjustment is most likely a function of several, but not all of the performance dimensions. For example, while a developer may determine that a user's pulse rate should correlation with several individual parameter adjustments, he may determine that the player's ability to navigate through complex hallways at a certain pace may be the only determinant of whether or not a team member in a military-based first person shooter game offers advice on which way to go next. For this reason, each individual parameter or group of settings (such as the ‘difficulty’ group, ‘level of graphic violence displayed’ group, ‘toolbar settings’ group, etc.) being adjusted should occupy its own table or section of a table so that each individual parameter can be adjusted according to those performance measurements that are relative to that parameter.

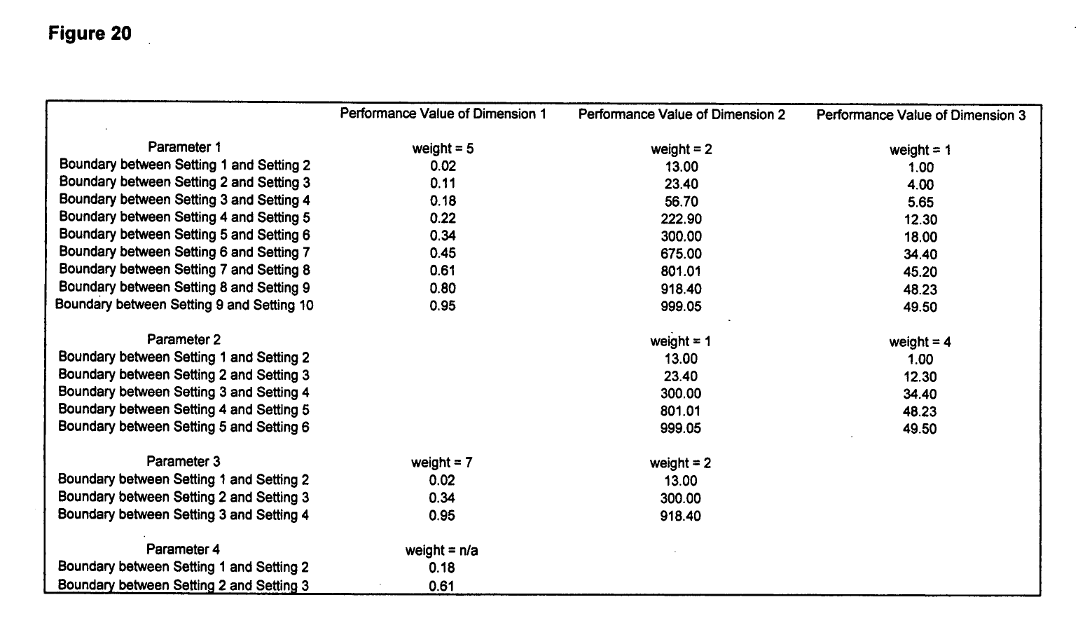

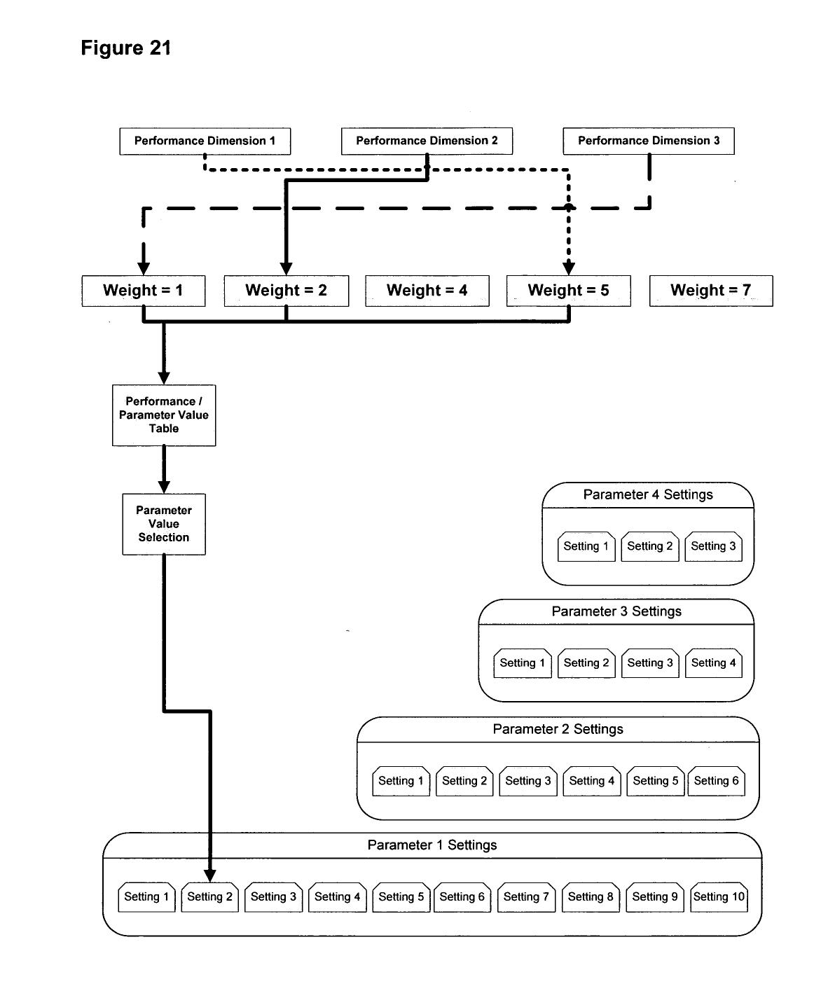

FIG. 20 is similar to FIG. 19 except that it shows four individual parameters being adjusted, each with respect to one or more of the three same performance dimensions in FIG. 4 (note that for each parameter, the weighting values and the number of distinct settings change as do the values that correspond to each setting). FIG. 21 shows a flowchart representation of this situation (for visual simplicity only the adjustments of Parameter 1 are shown).

In order to allow adequate resolution for automatic discrimination between game play at as many levels as possible, the number of distinct settings for each parameter should be maximal. In the prior art, the user was forced to quit the game program in order to manually change these settings. This was done with the intention that the new setting would provide better program interaction balance; however the number of distinct settings was relatively few providing poor resolution and often many such adjustments were necessary. Furthermore, primary use of the program often had to be reset to an initial condition as in the case of most videogames.

Dynamic performance evaluation and adjustment is a more advanced concept that requires that the game store the last performance measurement or parameter setting in memory in order to ‘iterate’ to the optimal setting by continually altering the direction of the user performance trend more aggressively than by a static method. In other words, static adjustment says, “the user's level of performance is level x, so that is the correct setting is level x”. In reality this method is only altering the direction of the performance trend inasmuch as the user will obviously perform at the new level with more or less success than the previous one, depending on whether that previous level was higher or lower respectively. This is only indirectly altering the direction of the user performance trend as a consequence of simply trying to set the correct level for the user's performance. With dynamic adjustment, if the user's level of performance was level x when it should be level x+1, then the correct adjustment is to level x+2. In this way, the program automatically and continually ‘zeroes in’ (iterates) on the user's performance level by constantly overshooting the adjustments to one side or the other. The iteration can be done with respect to predetermined values in tables (like those discussed above) or with respect to performance percentage differences based of the effects of parameter adjustments.

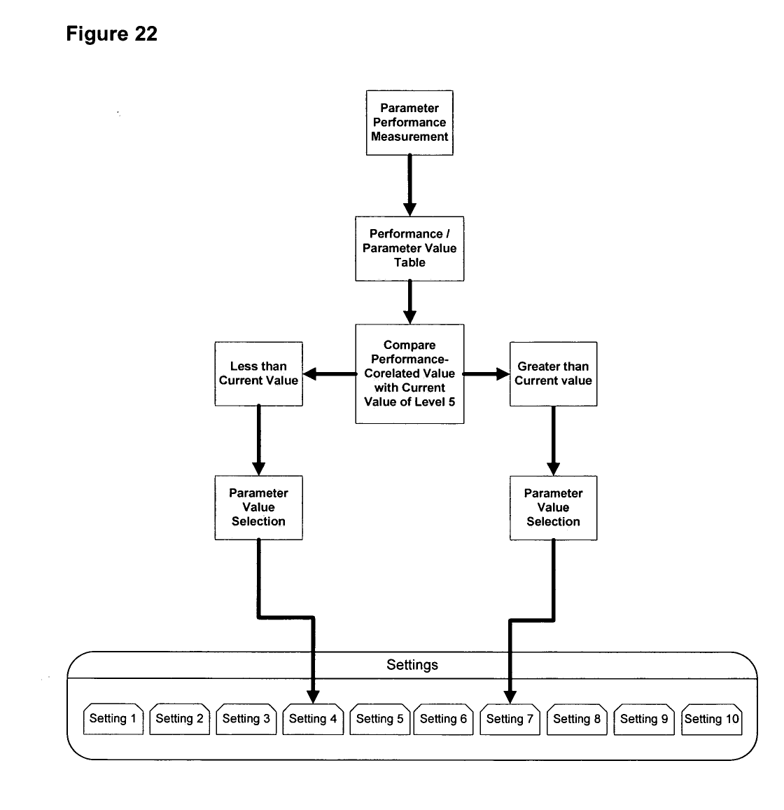

To illustrate dynamic adjustment with respect to a predetermined table, consider the simple situation in FIG. 16 again; there would only be one difference. Whenever the situation calls for a setting adjustment, and the determination is made about which new setting is appropriate, this method would make one additional calculation in order to overshoot the direction of the user performance trend in order to produce a higher probability of altering it. Assume that the current setting is setting 5 and the new setting is an increase to level 6, the control structure would actually select setting 7 to force a more aggressive alteration in the direction of the user performance trend, in this case a decrease in performance (see FIG. 22). Likewise if the new setting is a decrease from setting 5 to setting 3, setting 2 would actually be implemented, where the user's performance is more likely to increase. As with the invention in general, dynamic performance adjustment increases in value as the number of distinct settings for the parameters (or groups of parameters) increases.

As the number of distinct settings becomes smaller, this method of dynamic adjustment becomes less appropriate. With less than four settings there would be no value whatsoever (since the lowest and highest settings represent program extremes which cannot be overshot). However, the implementation of a performance-setting table can be extended to include a non-discrete continuum of possibility values for each parameter. In this implementation, the table serves as a guide, with a relatively few number of performance measurements—settings values correlations, as in FIG. 17. Assume that the user's performance was measured at value 0.20, which corresponds to setting 4. Setting 4, however, simply refers to one or more specific parameter values. FIG. 23 is similar to FIG. 17 except that it shows the particular parameter value settings. Assuming values to two decimal places, Setting 4 corresponds to performance values ranging from 0.18 to 0.22. In our current example, where the user's performance is measured at 0.20, his performance falls right in the middle of the range of Setting 4, so the selected values would be the same, Xₕₑᵣₒ=3.20 or memory_{sentrya}=12 kb. Consider that his performance is measured at 0.21. At this point it must be extrapolated. A value of 0.28 falls right in the center of Setting 5, so the user's performance is ⅛^{th} of the way between the central values of Setting 4 and Setting 5, so the selected parameter values would be xₕₑᵣₒ=3.30 and memory_{sentrya}=12.5 kb respectively.

When using a continuum of parameter possibilities, dynamic performance adjustment is the ideal implementation of the invention. In this case, the program automatically iterates to the user's precise performance level by continually altering the direction of the performance trend. As the resolution of the continuum increases (number of decimal points increases), distortion in user-program interaction would fall to zero, eradicating the inherent limitation in the prior art. This type of dynamic apposite implementation is one step below implementation of the full progressive dampening scheme (described previously).

When adjusting parameters at the individual level and utilizing a large number of discrete settings or a continuum of parameter possibilities, it is also necessary in most cases to perform consistency testing among parameter combinations, which is a major concern for program developers. As the number of parameters adjusted individually grows as does the number of parameter possibilities, automated methods for performing consistency checks among parameter value combinations can be created and used for testing phases, especially to ensure that a program does not ‘break’ with certain combinations.

With implementation at the parameter level, the invention can be applied to all parameters of the program which can relate to any measurable level of user input or performance. Now parameters which ultimately relate to user performance but could not be adjusted with a predefined static settings system, such as tightness of analog control, touchpad pressure sensitivity, navigation button versus action button sensitivity, command execution timing, combo entry buffer size, in-game training, even wins and losses, can be manipulated to balance and refine the user-program interaction further.

At the parameter level, it is also necessary for the program developer to consider parameter balance. With predefined groups of settings, this balance is already inherent; at the individual parameter level it is not. With this type of implementation the developers may wish for users to develop randomly with respect to each parameter or for users to improve in all areas at relatively the same pace; this is a developer's decision based on the program. The first requires no adjustment to the described system above. The second can be accomplished by any number of methods such as the use of additional subroutines added to the high level control structure which limits it's adjustment of parameter values. For example, the structure can simply not allow the relative level of any one parameter's setting to exceed that of another by some value (perhaps until more hours of program use have been logged). A simple example where all parameters have the same number of levels (otherwise linear extrapolation would be used) is that one parameter is set at level 5 and another at level 2. As the player's performance improves with respect to the first parameter again, instead of it being adjusted up to level 6, it is dropped to level 4 while at the same time the second parameter is adjusted up to level 3. Essentially this will both force and allow the player to put more attention into the needed development area. This might be preferable for general program presentation purposes or in some cases where needed skills should be developed in preparation for events at higher levels. Developers could design programs beyond this concern altogether by recording a precise relationship of how the adjustment of each parameter affects overall performance, so the control structure can effectively adjust the parameters in any manner (even at random) as long as they are adjusted in relationship so that the primary interaction scheme based on overall performance is maintained. Adjusting parameters at the individual such as shown in FIG. 20 will likely be necessary for the implementation of the invention into programs with fewer inherent goals, such as productivity software (word processors, database programs, etc.).

An embodiment of the invention is now provided with specific details for automatically managing the difficulty system within a videogame program. This type of program was chosen because its relatively high degree of inherent goals allows for an easier discussion of performance evaluation. This detailed embodiment employs both the static adjustment between predefined sets of parameter settings and dynamic adjustment of individual parameters, each with a continuum of possibilities.

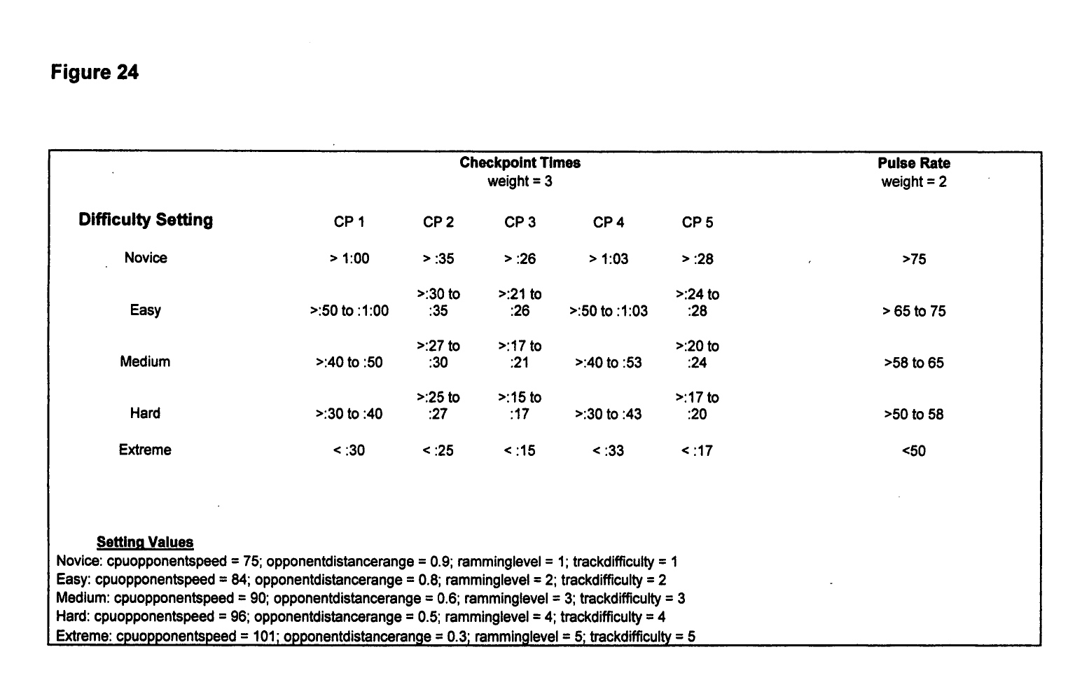

FIG. 24 shows a diagram of the invention applied to a videogame program based on a static performance evaluation method in order to adjust between predefined sets of parameter values corresponding to five general difficulty settings of ‘novice’ through ‘extreme’ based on the two performance dimensions of checkpoint times and player pulse rate. This example will assume 5 checkpoints per lap of a 3-lap race to be measured by the internal clock of the game console or computer and stored in a database file retrievable by the game program. These performance evaluation values and their corresponding difficulty settings which are shown in FIG. 24 represent an example of a retrievable file from the high level control structure implemented within the game program. This table of settings should be developed in the testing phase, taking into account developer concerns as well as averages of tester abilities. The pulse rate is measured at the same checkpoints from a standard biofeedback pulse monitor that reads from the index finger of the player; this type of instrument is easily integrated into a standard videogame controller.

The process works straightforwardly as discussed in the general implementation section above, performing performance evaluations and selecting the appropriate levels accordingly. For example, assume that at Checkpoint #1, measurement of the player's performance yields a Checkpoint #1 time of 55 seconds and a Pulse Rate of 54 beats per minute. According to FIG. 9, the driving speed evaluation corresponds to the center of the ‘easy’ setting range and the biofeedback-based evaluation corresponds to the center of the ‘hard’ setting range, so this obviously manufactured calculation is not math-intensive. The weight for the time dimension is 3 and that of the pulse dimension is 2, so we have:
[easy×(3)]+[hard×(2)]/(5 settings)
[2×3]+[4×2]/5=2.8
2.8 is closer to 3 than to 2 thus rounds to 3
Level 3=Medium Setting is selected

In this example, the process continues at every performance evaluation checkpoint until the last one yielding a generally balanced game experience for the player. When dealing with simple implementations like this one with a relatively limited number of performance evaluations, there are some concerns the developer should take into account: (1) that at least all of the performance evaluation points are not known by the player (e.g., placed randomly) so he does not play purposefully with respect to them, such as intentionally performing poorly during the last evaluation section in order to obviously improve with respect to the computer opponents on the last one in order to fraudulently improve his position in the race; and (2) what should the initial settings be (lowest setting, central setting, based on previous performance, etc.); and (3) how adjustments in difficulty, especially immediate multi-level adjustments, should be transitioned (e.g., the CPU opponent's vehicle is not going to go from 60 kph to 90 kph in one second, but rather needs to be transitioned). Dynamic methods deal with these concerns more inherently at will eliminate some altogether as will the adjustment of parameters at the individual level to some degree (discussed further below). Another implementation concern (4) is how to keep the player from purposefully playing at a less than optimum ability. This potential issue is discussed above with reference to FIG. 7.

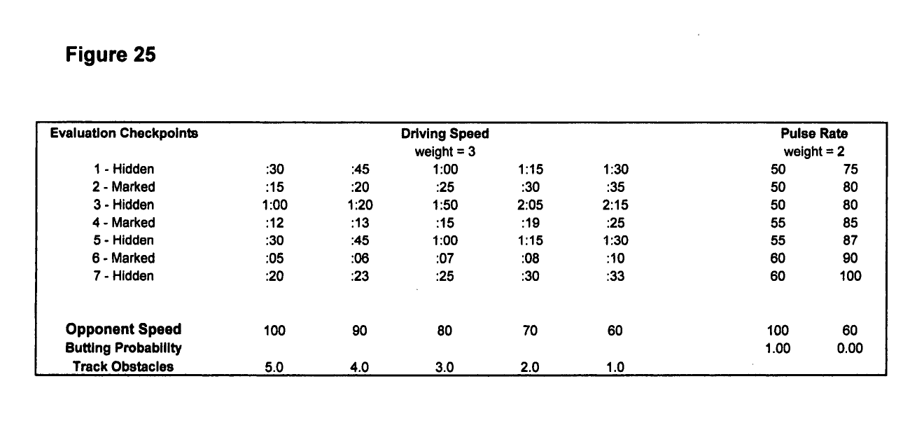

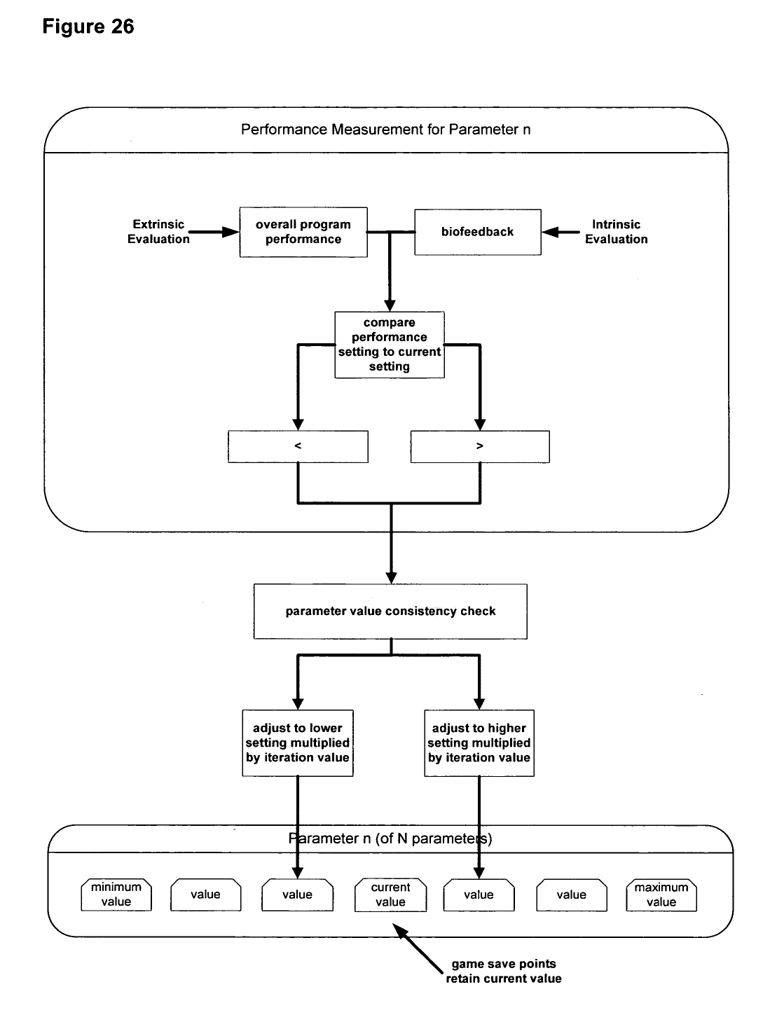

The next example as shown in FIGS. 25 and 26 deals with dynamic performance evaluation and adjustment of individual parameters with a continuum of possibilities. This example additionally implements a progressive negative feedback dampening scheme like those discussed in earlier examples, but uses the predetermined numerical settings system as opposed to a single optimal baseline. In this example, trends of player performance are measured through time to a provide negative feedback dampening scheme (with 0.1 as the iteration value as opposed to the ½ used in the previous examples) but there is no player performance—parameter value statistical correlation like in the earlier examples. Consider a different race within the same racing videogame above. FIG. 25 shows the performance-setting relationships. This table differs in that each performance value has a direct corresponding parameter value setting for each individual parameter: Opponent Speed, Butting Probability, and Track Obstacles (only three parameters are shown whereas in a large-scale racing simulation the number should be much greater). Two of the performance evaluation dimensions are the same as in the previous static example, namely checkpoint times and pulse rate. As is indicated in the table, the number of pulse rate evaluations is the same as before, but the checkpoint times now include three that are apparent to the player during each lap, and an additional one randomly placed between each of these marked checkpoints and the race start and endpoints (for a total of seven driving speed performance evaluations). Furthermore one additional performance evaluation dimension is included: the frequency with which a computer opponent's vehicle within range to do so will butt against the player's vehicle. Note that the CPU Opponent Speed is adjusted as a function of both player checkpoint times and pulse rate. Butting Probability is a function of only the player's pulse rate, and the Track Obstacle Propensity is a function of only the player's checkpoint times.

Assuming the player begins the race, the program automatically selects the middle setting for each parameter as a start point, that is Opponent Speed=80 kph, Butting Probability=50% and Track Obstacle Propensity is set to add 3 additional objects (such as a dumpster, additional traffic car and some road debris) from the start of the track to the next marked checkpoint. The player reaches the first hidden evaluation checkpoint with a time of 48 seconds and a pulse rate of 55 beats per minute. Referring to the table in FIG. 10, we can see that in terms of Driving Speed for Checkpoint 1, times between 45 seconds and 1:00 (the tested times) refer to an Opponent Speed between 90 and 80 kph. A player performance time of 48 seconds specifically translates to a speed of 87 kph. In terms of Pulse Rate for Checkpoint 1, rates between 50 and 75 bpm correlate to Opponent Speed Settings of 100 to 60 kph. A pulse rate of 55 bpm correlates to 92 kph. So the variable parameter of CPU Opponent Speed is calculated as follows:
[Dimension1 value×weight 1]+[Dimension2 value×weight 2]/total weights
[87 kph×3]+[92 kph×2]/5=89 kph
the Butting Probability=80%
the Track Obstacle Propensity is=4.0

In this example, there is one additional set of calculations necessary before adjustment. The parameter settings began at the central settings of Opponent Speed=80 kph, Butting Probability=50% and Track Obstacle Propensity=3. The player's performance according to the table (again, created in the testing phase) warrants Opponent Speed=89 kph, Butting Probability=80% and Track Obstacle Propensity=4.0. In this example the program will seek to alter the direction of the user performance trend directly through an iterative process (strength of iteration given by value=1.1) as follows:

| | |
|---|---|
| Opponent Speed | |
| Current Setting = | 80 kph |
| Evaluated Opponent Speed = | 89 kph |
| Difference = | +9 kph |
| Trend Alteration = | (1.1 × difference) rounds to +10 kph |
| Actual Adjustment = | 90 kph |
| Butting Probability | |
| Current Setting = | 50% |
| Evaluated Butting Probability = | 80% |
| Difference = | +30% |
| Trend Alteration = | (1.1 × difference) = +33 kph |
| Actual Adjustment = | 83% |
| Track Obstacles | |
| Current Setting = | 3.0 additional obstacles |
| Evaluated Obstacle Propensity = | 4.0 additional obstacles |
| Difference = | +1.0 additional obstacles |
| Trend Alteration = | (1.1 × difference) = +1.1 add. obstacles |
| Actual Adjustment = | 3.1 rounds to 3 additional obstacles |

After these calculations, the parameters are transitioned over the next 12 seconds (one quarter of his section 1 time) to their new settings of 90 kph, 83% and 3 obstacle additions respectively. Based on the user's last performance evaluation, these settings should be more difficult than his ability and each setting should have a more than 50% probably of being reduced after the next evaluation.

As the player is still racing, he reaches the second performance evaluation point at which the program evaluations his performance at 23 seconds and an average pulse rate of 60 bpm for the second evaluation section. These performance levels correlate to parameter settings of 84 kph, 60%, and 3.4 obstacles respectively. Again, the performance trend calculation is then performed:

| | |
|---|---|
| Opponent Speed | |
| Current Setting = | 90 kph |
| Evaluated Opponent Speed = | 84 kph |
| Difference = | −6 kph |
| Trend Alteration = | (1.1 × difference) = −7 kph |
| Actual Adjustment = | 83 kph |
| Butting Probability | |
| Current Setting = | 83% |
| Evaluated Butting Probability = | 60% |
| Difference = | −23% |
| Trend Alteration = | (1.1 × difference) = −25% |
| Actual Adjustment = | 58% |
| Track Obstacles | |
| Current Setting = | 3.1 additional obstacles |
| Evaluated Obstacle Propensity = | 3.4 additional obstacles |
| Difference = | +0.3 additional obstacles |
| Trend Alteration = | (1.1 × difference) = +0.3 add. obstacles |
| Actual Adjustment = | 3.4 rounds to 3 additional obstacles |

After these calculations, the parameters are transitioned over the next 6 seconds (one quarter of his section 2 time) to their new settings of 83 kph, 58% and 3 obstacle additions, respectively. Based on the user's last performance evaluation, which lowered the difficulty with respect to Opponent Speed and Butting Probability, these settings should be less difficult than his ability and each setting has a more than 50% probably of being increased after the next evaluation. Obstacle Propensity is not a very well resolved parameter, since only whole objects can ultimately be placed on the screen, therefore the adjustment to up to 3.1 and then again to 3.4 has yet to have an actual effect on the player which should have an effect on the alteration of the setting.

As shown in FIG. 26, the process continues throughout the remainder of the race. The adjustment in parameter settings from one evaluation point to the next will become a smaller and smaller interval. Not only does the process ‘zero-in’ on the correct setting for each parameter relative to user performance, but this iterative process continues to account for user performance improvement due to player learning (better or worse). As a result, distortion in player game interaction will fall to zero, and frustration and boredom are quickly eradicated. The adjustment method makes it essentially impossible for players to be successful at game objectives through the use of predetermined patterns of play.

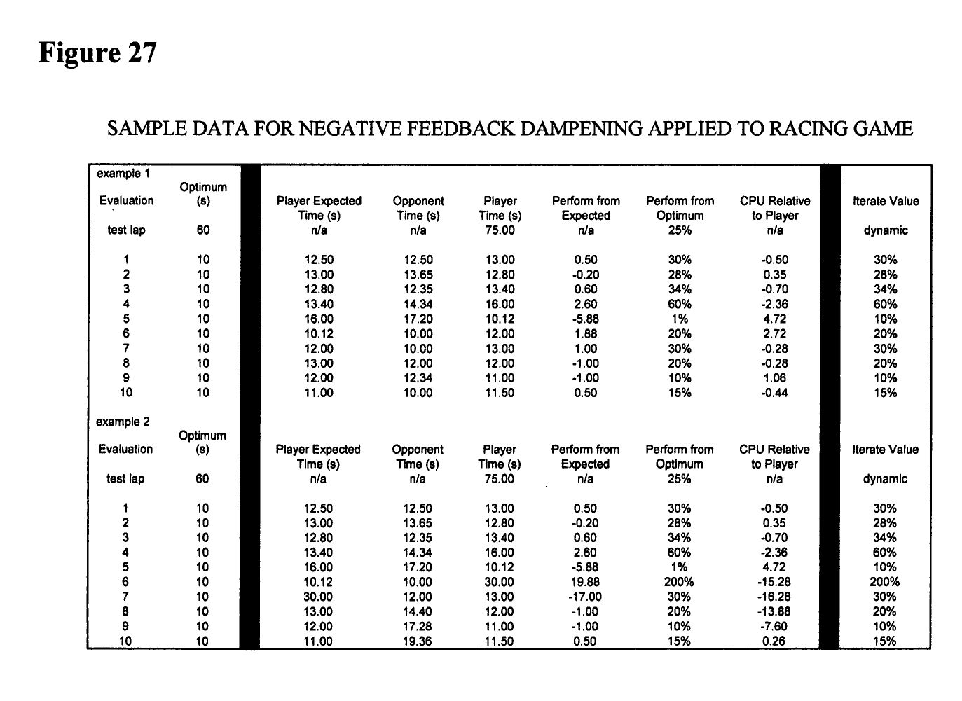

FIG. 27 shows sample numerical data for a 2 race examples which apply the progressive negative feedback dampening scheme (such as that shown in FIG. 9) and further implements a dynamic iteration magnitude value (rather than the constant values such as 0.1 or ½ discussed in previous examples). As indicated in Example 1 in the figure, the iterate or dampening magnitude is the simply absolute value (by percentage) of the player's performance from the baseline optimum. The player runs a time trial test lap so the program can determine his general ability, and this is used to control the CPU opponent's speed during the first race segment up to checkpoint #1. In the example, the player's performance in segment #5 (as measured by evaluation point 5) is a relatively larger deviation from the expectation, especially considering his relatively poor performance on segment #4. For this reason, it takes the CPU opponent 2 race segments to apply the negative feedback since in this example the CPU opponent is constrained to not exceed the optimum time as allowed by game physics. As indicated by the ‘CPU relative to player’ numbers, the player retakes the lead in segment 9 and is finally passed again in segment 10 in which he loses the race. Example 2 is identical, and the mathematical response scheme is the same. In this example, the player's performance time for segment 6 is a very slow 30 seconds (perhaps due to some crash). However, the CPU opponent's resonant response dampens this aberration over several checkpoints and the player slowly catches up, passes the CPU opponent in the final segment and eventually wins the race by just over a ¼ second.

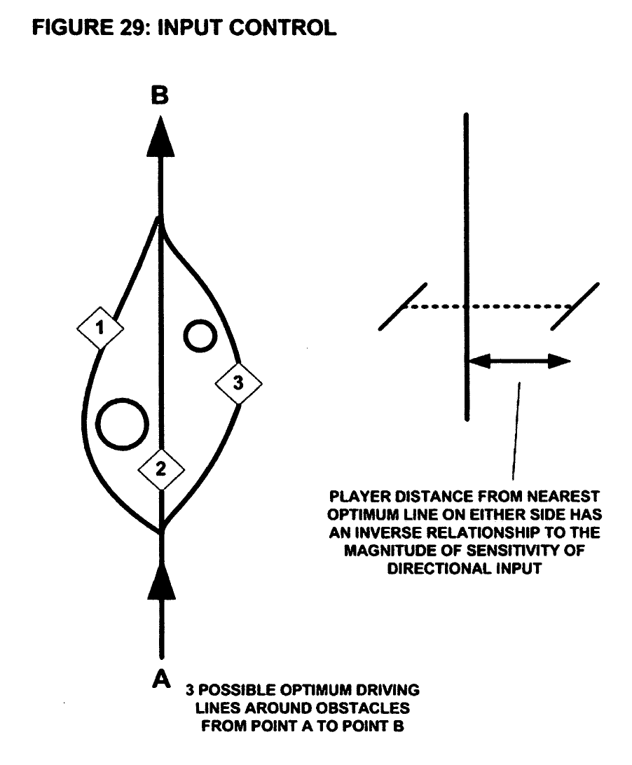

As illustrated in FIG. 28, the invention can be implemented at various levels. Most of the above examples have shown and discussed implementation at the levels of REAL-TIME GAME DIFFCIULTY, META GAME DIFFICULTY, AND CONTENT GENERATION. The invention can also be used to apply adjustments to effects of INPUT CONTROL according to the same scheme. For example, adjustments could be made to an analog controller's input effect based on player performance relative to an optimum line in a race, etc. (see FIG. 29). Execution timing of command inputs can also be progressively balanced with player input performance according to the negative feedback dampening scheme, in order to further help players interact with the game. For example, a command which controls a player character in an adventure game to pick up an object can have a floating input timing buffer range based on player capability. Over time, the player and game will learn to communicate progressively effectively and the player will learn the appropriate timing within a positive reinforcement system rather than a negative one. Player commands to turn in a race can be executed at slight time deviations in order to improve performance, etc.

LEVEL PERFORMANCE itself is a yet a higher level of implementation. For example, rather than simply in-race checkpoints, race finishing results can further apply the invention scheme in order to progressively balance game challenge with player capability through time. For example, if the player won the last race, he should have reduced odds of winning the next one. When done directly, such as illustrated in FIGS. 31 and 33, it modifies player level performance (such as finishing position or win/loss in a fight, time through an entire race or battlefield arena, etc.). The concept of level performance can additionally be extended to even higher levels, such as player finishing results over time, how many higher level wars were won rather than smaller level battles, or success over multiple games (networked together) such as combined wins and through-time performance. When done more indirectly, by modifying real-time parameter adjustments by some percentage based on player results or trends (as shown in FIG. 11) where modifications may or may not be made to parts of a level (such as some segments in a race) to account for trends in player performance and confounding variables, it is referred to as ‘meta-adjustments’ or ‘meta-game difficulty’. In some implementations there may be a grey area between ‘meta game difficulty’ and ‘level performance’ levels, the latter being more direct. The two are not mutually exclusive.

As illustrated in FIG. 28, the highest level of implementation in a game would be considered GAME EXPRESSION. At this level, the game itself would not only include but more broadly be based on the invention scheme. For example, if success in the game was dependent on communication between a player character and a computer-controlled non-player character (NPC) or between a player character and other player characters in multiplayer games, this following communication scheme may be used. For example, the computer-controlled NPC could be a cooperative agent in the game (such as a battalion member in a military simulation) rather than a competitive opponent. The NPC's attempt to cooperate with the player may work by dampening deviations from expected or predicted player behaviors based on past performance. This represents a game which ‘expresses’ the invention scheme, as only by the player learning the method by which the NPC is reacting can they truly cooperate together.

In summary, there are two general methods for applying the invention scheme. The first is the progressive dampening system discussed with respect to FIGS. 1, 2, 3, 4, 5, 6, 7, 8, 9, 10, 11, 12, 13, 14, 15, 22, 26, and 27. This scheme is represented by the altering of the player performance trend through time by decreasing delta magnitudes. With this implementation, the game continually overcompensates in order to eliminate lag time between variations in player performance and calculated resonant game response. The second basic approach is an apposite scheme represented in FIGS. 3, 4, 6, 7, 14, 16, 17, 18, 19, 20, 21, 23, 24, and 25. This method simply selects an appropriate one of several predefined levels for game parameters based on comparing measured player performance against predetermined threshold values chosen by the game developers. The progressive scheme is preferred, and is stronger due to the entrainment principle. The apposite scheme is more likely to be usable with existing game architectures.

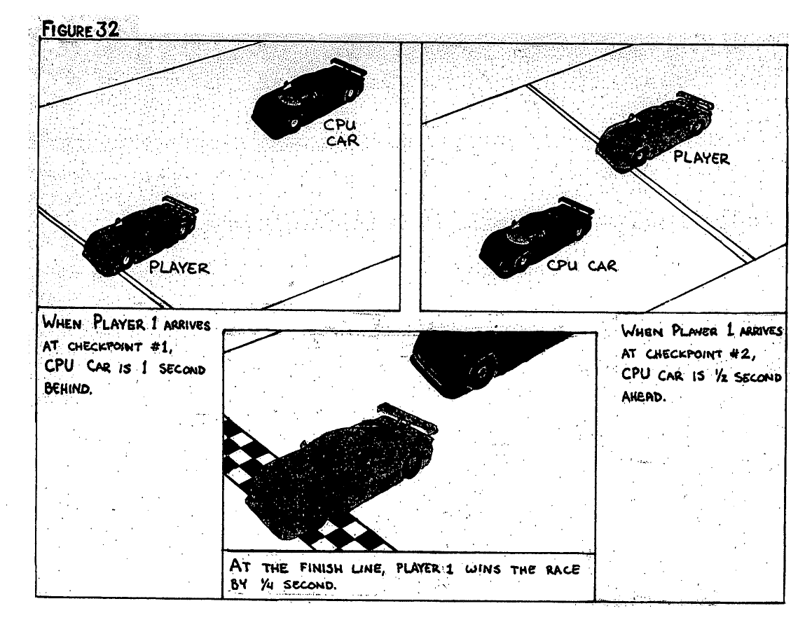

FIGS. 30 and 32 are visual representations of the progressive negative feedback dampening scheme applied to a racing simulation videogame. As explained previously, the Logic Engine predicts the player's arrival time at each performance evaluation checkpoints and adjusts the CPU car velocity to arrive at the checkpoints relative to the player car so as to continually (at each checkpoint) alter the direction of the performance trend (which car is leading) and to reduce the magnitude of the difference of the arrival times of the respective cars by some constant or dynamic value.

FIG. 31 is a visual representation of a racing game in which there are multiple CPU opponents. Based on previous race results, 2^{nd} place in the race is the correct finishing position for the player under the applied scheme. In order to increase the likelihood of a 2^{nd} place player finish, the negative feedback dampening scheme or apposite scheme is applied to a floating position ½ the distance between the first two of three CPU opponent cars. FIG. 33 is a visual representation of a similar racing game except that the correct finishing position for the player under the applied scheme is a 50/50 probability of either 2^{nd} or 3^{rd} place. In this case, the negative feedback dampening or apposite scheme is applied to the middle CPU car, whose average race position is midway between the two white ‘dummy’ CPU opponents.

Other Variations for Applying the Invention to Interactive Game Applications

The major benefits of the invention for interactive games are the reduction of frustration and boredom in user-program or player-game interaction leading to a more enjoyable experience and a faster learning curve for the player. For this reason, the invention has obvious value to the educational and training industries as well. Either the apposite scheme or the progressive dampening scheme could be applied to allow players to learn by a system which adjusts difficulty parameters to be equal at any given time to player capability. Interacting with a program working according to this principle would help users learn at an optimal rate through positive feedback reinforcement of successful behaviors (as the inherent negative feedback response scheme essentially reduces unsuccessful behaviors through time).

There are of course many additional possibilities for applying the invention method to interactive games. The difficulty adjustment can be extended outside the primary game play space (for example, the number of wins and losses could be used to literally predetermine race or other game outcomes). Parameters which previously related to game difficulty can be adjusted to relate to other aspects such as game enjoyment (perhaps defined through biofeedback patterns). Users could be allowed to explore objectives other than those defined within the program; user patterns could evolve into goals at which point the program would provide scenarios that enhanced those particular goals. Game areas other than difficulty can be manipulated in the same manner as long as there is some method of evaluating the relationship of the player's inputs to these game areas. Furthermore, parameter adjustments can be made based on ever subtler user inputs (for example, pulse rate and galvanic skin response could completely control the player's character or vehicle). This direction would ultimately be represented by a neurological feedback system. It was stated earlier that the invention can be implemented into any program with inherent goals; that is not to say that the user need be consciously aware of these goals for the invention to operate. At some point, user inputs and performance evaluation could be abandoned altogether as the game or other program would adjust user performance values as simply other parameters of the program—perhaps being run by a collective structure of many users connected together by the program.

This implementation can extend the player-program in an additional dimension, allowing for further uses. The program can adjust parameters so they are balanced for each individual player according to the primary scheme and then balance the players with respect to each other. This application could be used for as many players as the game program allows. With the rise of popularity in multiplayer gaming, especially due to online capabilities of computers and recent console game systems, the possibilities for this application are extensive.

Trends through multiple evaluation points through time can also be measured for more advanced prediction and more complicated negative feedback schemes (possible more transparent to the player). These trends through time could also be used to trigger optimal placing for in-game advertising (advertisers may want players to be in an engaged state at the moment an ad is displayed). The measurement of performance trends as part of the adjustment process may provide predictions for these states.

As another type of program implementation, dynamic advertising content may constitute one or more of the parameters. Advertising such as this is likely to be triggered during real-time play based on statistical confidence intervals determined by the prediction and forecasting modules. For example, as the game program predicts with increasing accuracy which specific events and forecasted combinations of parameter values (taking into account the forecasted effect of the ad along with the other parameters) are simultaneous with some level of confidence of resonant interaction, in-game ads stored in game data can be triggered to occur at specific moments where player-game interaction flow is higher. This would be optimal for advertising, as flow states are more conscious and better remembered. This implementation would be increasingly effective as the number of adjustment points increases.

The primary purpose of performance evaluation is to correlate the effect of game settings on player performance. There might be n race segments corresponding to n−1 opportunities for the game to adjust difficulty settings, but there could be many more performance evaluation points to record information to statistically correlate. However, the number of performance evaluations should be no less than the adjustment locations, as adjusting with no additional information would simply lead to the same settings.

Along with improved game experience, the parameter adjustment method of the invention can produce games which have several other advantages. These include advantages to player health such as decreased frustration and boredom, smaller mood swings during play, more balanced psychological and emotional states), and since biofeedback inputs may ultimately be regulated through user-program interaction, fewer negative side effects such as epileptic seizures and brain disorders commonly a concern for many videogame and parents, especially videogames. The videogame business model would benefit in many ways, such as application to upgrade a limitless library of existing games. Games could be created and marketed with the unique feature of being perfectly balanced for all users. The size of potential users for the games would grow (wider audiences), the programs would be more engaging and provide the psychologically-defined peak experiences that gamers love in a relatively short amount of time per game, and the reusability of all programs would increase as the programs would evolve with the user. Advertising would benefit from being able to be placed when certain levels of user-program interaction had been reached for better message communication and online capability and uploading would provide a natural return path to allow effectiveness of the ads to be analyzed, perhaps even by an automated process. The global nature of the parameter adjustment process lends itself to game element downloads, monthly subscriptions, player data uploads, etc.

Possibility for program control ultimately being subtler and less physical, perhaps eventually run by biofeedback inputs, even neurological, could lead to telepathically controlled gaming. As confidences of statistical prediction grow between a game and player to a high enough accuracy, game play could eventually occur completely at the direction of the game program entrainment system while simultaneously giving the player the impression that he was controlling his choices. This process of generating content based on predictions could lead to directed outcomes (created by developers or advertisers) and their related psychological states, eventually eliminating the need for player inputs and performance evaluation altogether (transparently to the player) as the game program would adjust player performance values as simply other parameters of the program. This level of implementation might first be run by a multiple-user collective connected by a common (or even different) game program(s).

Applying the Invention to Other Interactive Applications

It has already been discussed that the invention can be implemented into any program in which there are inherent program goals. Consider productivity software, such as a word processing program. The program opens and the user is given several choices, such as whether to construct a personal resume, business letter or screenplay. Performance can already be measured at this selection step (for example by how much time it takes the user to choose). After the type of document is selected, parameters are already being set (such as font, layout, and further options from which to be selected). Now there are more choices (such as which style) and more specifically defined goals (such as writing the personal objective of the resume, then the work experience and education sections). Inasmuch as goals become apparent to the program, parameters can be adjusted based on user performance toward these goals. T Theoretically, if productivity software were composed primarily of decision trees and automated templates, performance of every aspect could be measured. In this example, the entire writing of a resume could be run by the measure of user's biofeedback which would represent certain physiological reactions to the choices being presented. If too much time was taken, help or other options might be presented. Of course, as with the game programs described above, the initial implementations of the invention will likely have to be done with respect to existing software structures, so the initial implementation with productivity software will likely be the adjustment of a relatively few number of individual parameters according to obvious user goals.

Virtual reality programs are another location for the application of the invention. The VR program may have inherent goals or may actually be a game or productivity program of some sort. This is the optimal type of program for discussion some additional possibilities. The sensory output of the program need not have any predefined structure whatsoever and can continuously arise and fall away as a function of user feedback. For example, the visual output may be to a screen of some sort with a set number of pixels which can on various colors, brightness levels, etc. The parameter values could initially be random for the pixels, and as the user sees patterns begin to develop that cause physiological reaction, those patterns develop or fade away according to the principles of the invention. This will create a stable interaction and virtual environment. Other sensory types (audio, kinesthetic, olfactory, etc.) could be integrated in the same way.

Health-related programs are another area of likely application. There are many techniques for improving physiological health depending on the desired level of balance to be attained. Across many levels, there are various forms of exercise geared toward increasing lung capacity and heart rate variability. At higher levels, brainwave entrainment programs and meditation practices are often used. However, current mind-body devices are either linear predetermined programs or some form of biofeedback which are only effective within a certain range and do not provide feedback that directly and necessarily improves the performance of the user. The ultimate interactive program for achieving mental or physical balance would continually react to a fluctuation in the user's state in a way that would reduce the effect of the fluctuation. For the ill user, this would reduce drastic fluctuations in thoughts and emotions, providing a calming effect and allowing them to interact more normally. For the athlete, this would provide the many of the benefits of exercise without the effort or having to push oneself at all. For the meditation practitioner, thought could be stilled and a deepened sense of peace and centered focus developed. A physiological balancing machine could incorporate sensing equipment appropriate to one or more forms of biofeedback such as (1) Inverse of Heart Rate Variability, (2) Pulse Rate, (3) Galvanic Skin Response, (4) Brainwave Activity, (5) Eye Movements, etc. Such a machine would also incorporate one or more forms of output, such as visual, auditory, kinesthetic or other sensory information.

The program's primary function would be to provide sensory output that reduced any physiological distortions. Again, this does not mean continually attempting to relax the user, but rather to relax the user when user relaxation decreases and to excite the user when user relaxation increases. Once again, it is only this bidirectional method of feedback that will lead to a stable interaction between user and program/machine, and only this stable relationship can continue to steadily evolve so that an instrument can help the user reach a goal.

Other health-related uses might include such programs as sensory kinesiology feedback, a counseling program trained to probe the user's emotional responses, a psychic program trained to probe into subtler areas of the user's consciousness (similar to therapy), and a program design to deprogram melodies, traumas, thoughts or beliefs according to the same principle.

More direct advancements in the field of information technology might be the result of the invention's implementation in specific types of training or learning programs, such as natural language programs.

The invention can also be applied to entertainment programs, such as a television show or an electronic book program which can be communicated to a user through audio or words on a visual monitor such as a computer or PDA screen. Previous efforts at books with branching plots have included options for the reader at the end of various sections. For example, as the mystery behind the door was about to be revealed, the reader was given several options which corresponded to respective page numbers that could be turned to at which point the story would continue along the chosen path. In this case, the invention could be applied to automate this selection process. For example, as branching user selection points are encountered, the chosen path will be selected transparently to the user depending upon user biofeedback. For example, as the possibility of a murder increases in the storyline, the user's pulse may increase so quickly that the process determines that more descriptive lead-up information is warranted to allow for a steadier user state. With nonfiction books, the biofeedback may indicate to the program that the student or reader was not relaxed enough during the previous explanation to fully assimilate the information; therefore that particular section will now be described in further detail. The invention can be extended to any level of depth here, ultimately determined by the number of branching points. This can be done at chapter, section, paragraph, sentence or even word level depending on the resolution of the biofeedback and the speed and complexity of the program. In the most advanced theoretical case, the book would essentially be writing itself as it went according to the user reaction to the words. Psychology books could literally provide treatment for the reader as they read it, continuing to explore certain aspects of the human psyche, childhood-type events, etc. as the user reacted to them. General areas would become more specific and more personalized with progress. Applications could be constructed for scholastic textbooks, spiritual books, fiction and so forth. The application of this same principle could ultimately be applied to movies, or even commercials and television programs as return path technologies evolve.

The invention can be implemented to an entire program or specific parts of it. The invention can create the appearance of responsiveness (complexity, intelligence, and/or consciousness) more efficiently and with less processor usage than lower level AI structures based on linear rules. Architectures (such as the high level control structure of the invention) that support high level commands, goal-based decisions and timer-based decisions often result in emergent behavior. The programs created according to the invention could be designed for wider audiences of users in the intended audience groups.

It is to be understood that many modifications and variations may be devised given the above description of the principles of the invention. It is intended that all such modifications and variations be considered as within the spirit and scope of this invention, as defined in the following claims.

1. A method for adjusting one or more parameters of interactivity between a user and an interactive application program programmed for operation on a computer, wherein the interactive application program is operable to measure a difference between one or more parameters of user performance input to the program and the program's interactive output to the user, and to adjust the corresponding parameters of successive interactive output by the program so that the difference between the user's performance and the program's interactive output is progressively reduced.

2. A method for adjusting one or more parameters of interactivity of an interactive application program according to claim 1, wherein the adjusting of parameters of interactive output is obtained through negative feedback dampening.

3. A method for adjusting one or more parameters of interactivity of an interactive application program according to claim 2, wherein the negative feedback dampening is obtained by dampening the parameters of the interactive output in a direction opposite to and by a fractional amount of the measured difference in user performance.

4. A method for adjusting one or more parameters of interactivity of an interactive application program according to claim 1, wherein the adjusting of parameters of interactive output is obtained through selection of a corresponding one of apposite predetermined values for the parameters of the interactive output.

5. A method for adjusting one or more parameters of interactivity of an interactive application program according to claim 4, wherein the selection of apposite predetermined values is obtained by associating ranges of measured user performance with respective setting values for interactive output, and selecting the setting value for the interactive output associated with the range in which the currently measured user performance lies.

6. A method for adjusting one or more parameters of interactivity of an interactive application program according to claim 1, wherein the adjustment of parameters of interactive output is performed by dynamic generation of interactive output.

7. A method for adjusting one or more parameters of interactivity of an interactive application program according to claim 1, wherein the adjustment of parameters of interactive output is performed by selecting premodeled segments of interactive output.

8. A method for adjusting one or more parameters of interactivity of an interactive application program according to claim 1, wherein the interactive application program is an interactive video game program programmed for operation on a computer, and the adjustment of interactive game parameters progressively reduces the difference between user performance of the game and the game output.

9. A method for adjusting one or more parameters of interactivity of an interactive application program according to claim 8, wherein the video game program is a racing simulation game, and the user's racing performance is measured against a program-generated racing scene.

10. A method for adjusting one or more parameters of interactivity of an interactive application program according to claim 8, wherein the video game program is a racing simulation game, and the user's racing performance is measured against a computer-controlled race car.

11. A method for adjusting one or more parameters of interactivity of an interactive application program according to claim 8, wherein the video game program is a racing simulation game, and the user's racing performance is measured against multiple computer-controlled race cars.

12. A method for adjusting one or more parameters of interactivity of an interactive application program according to claim 1, wherein the interactive application program is an interactive educational game program programmed for operation on a computer, and the adjustment of interactive output parameters is performed by generating educational game content that reduces the difference between user performance of the educational game and the game content.

13. A method for adjusting one or more parameters of interactivity of an interactive application program according to claim 1, wherein the interactive application program is an interactive productivity application program programmed for operation on a computer, and the adjustment of interactive output parameters is performed by generating productivity interaction content that reduces the difference between user performance of the productivity application and the productivity interaction content.

14. A method for adjusting one or more parameters of interactivity of an interactive application program according to claim 1, wherein the interactive application program is an interactive training application program programmed for operation on a computer, and the adjustment of interactive output parameters is performed by generating training interaction content that reduces the difference between user performance of the training application and the training interaction content.

15. A method for adjusting one or more parameters of interactivity of an interactive application program according to claim 1, wherein the interactive application program is a biofeedback application program programmed for operation on a computer, and the adjustment of interactive output parameters is performed by generating biofeedback interaction content that reduces the difference between user performance of the biofeedback application and the biofeedback interaction content.

16. A method for adjusting one or more parameters of interactivity of an interactive application program according to claim 1, wherein the interactive application program is an entertainment program programmed for operation on a computer, and the adjustment of interactive output parameters is performed by generating successive entertainment content balanced to user reactions represented by user input.

17. A method for adjusting one or more parameters of interactivity of an interactive application program according to claim 1, wherein the interactive application program includes embedded advertising that is provided as interactive output based on the user's measured performance input.

18. A method for adjusting one or more parameters of interactivity of an interactive application program according to claim 1, wherein the adjustment of parameters of interactive output is performed by projecting a future trend of user performance based upon previously measured values of user performance.

19. A method for adjusting one or more parameters of interactivity of an interactive application program according to claim 1, wherein the adjustment of parameters of interactive output is performed by modifying control of input devices for user input such that successive inputs can be progressively balanced with user performance.

20. A method for adjusting one or more parameters of interactivity of an interactive application program according to claim 1, wherein the adjustment of parameters of interactive output is performed by progressively modifying the interactive application's challenges to user capability over time.
